(19) United States
(12) Patent Application Publication
(10) Pub. No.: US 2002/0072380 A1
(43) Pub. Date: Jun. 13, 2002

(54) Mobile communications system using a fixed wireless telephone network

(76) Inventors: Ken Takashima, Kawasaki (JP); Yasushi Miyagawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/918,955

(22) Filed: Jul. 31, 2001

(30) Foreign Application Priority Data
Dec. 12, 2000 (JP) 2000-377557

(51) Int. Cl. H04Q 7/20

(52) U.S. Cl. 455/461; 455/459; 455/458

(57) ABSTRACT

An inter-controller SW device, which broadcasts a message, or routes a message from a mobile station, is arranged between a base station controller and base station transceiver subsystem in a fixed wireless communications system, so that a communications path can be formed as the mobile station moves. In the fixed wireless communications system, the inter-controller SW device copies the message from the base station controller for which setting is made to make a mobile station belong to, and routes the message with a communication between inter-controller SW devices so as to allow a message to be transmitted also from a base station transceiver subsystem subordinate to a base station controller to which the mobile station does not belong, other than the base station controller to which the mobile station belongs. Additionally, a message from a mobile station that moves is routed with a communication between inter-controller SW devices, etc., so that the message reaches the base station controller to which the mobile station belongs.

### BACKGROUND OF THE INVENTION

1. Field of the Invention

The present invention relates to a mobile communications system using a fixed wireless telephone network.

2. Description of the Related Art

In a wireless mobile communications access system and a wireless fixed communications access system (hereinafter referred to as a wireless access system), a base station controller comprises a voice codec processing unit. For example, a voice codec processing unit and an application technique peripheral to the voice codec processing unit of the base station controller in a wireless access system using a CDMA (Code Division Multiple Access) method for use in an IS-95-A system, etc., are vital.

Currently, it is required to enable a mobile communications system to be easily implemented by using an existing fixed communications access system network.

FIG. 1 exemplifies the configuration of the wireless access system.

By way of example, in a mobile communications system (cellular system) included in a general wireless access system, a PSTN (Public Switched Telephone Network) and a mobile communications network are connected by an MSC (Mobile Switching Center), a BSC (Base Station Controller) is connected subordinately to the MSC, and a plurality of BTSs (Base station Transceiver Subsystems) are connected subordinately to the BSC, as illustrated as a CDMA cellular/PC network in FIG. 1. Each of the BTSs communicates with an MS (Mobile Station) that is staying within the cell of the BTS itself to provide a service such as a mobile station telephone service, etc. At this time, the positional information of the MS is managed by the MSC, so that the MS can move between MSCs.

In the meantime, a fixed wireless access system (WLL) illustrated in the lower left portion of FIG. 1 is connected to the PSTN by an LE (Local Exchange), a BSC is connected subordinately to the LE, and a plurality of BTSs are connected subordinately to the BSC. Each of the BTSs communicates with an SU (Subscriber Unit) that resides in the cell of the BTS itself and cannot move, so that a telephone service equivalent to a public phone service can be provided.

In a conventional mobile communications system, a mobile switching system is essential. To start a mobile system service, a wireless mobile system subordinately to an exchange must be newly arranged.

### SUMMARY OF THE INVENTION

It is an object of the present invention to provide a configuration for building a simple and low-cost mobile communications system in a fixed wireless communications system.

The mobile communications system according to the present invention comprises an inter-controller SW device that relays voice data and control data, which are exchanged between a wireless base station controller (BSC) and a plurality of wireless base station transceiver subsystems (BTSs), between an arbitrary wireless BSC and an arbitrary BTS, in a fixed wireless telephone network that is configured by at least a fixed network local exchange (LE), the wireless BSC subordinate to the fixed network LE, and the plurality of BTSs.

According to the present invention, the inter-controller switch device relays necessary information, notifies a mobile station (MS) that moves of the information, and relays the data of the MS, which is transmitted from the move destination, to a fixed network LE to which the MS is first registered, instead of a fixed network LE that cannot manage the move of an MS. Therefore, an MS can be easily accommodated in a fixed wireless telephone network that can conventionally accommodate only a fixed station.

### BRIEF DESCRIPTION OF THE DRAWINGS FIG. 1 exemplifies the configuration of a wireless access system;

FIG. 2 shows the principle of the configuration of one preferred embodiment according to the present invention;

FIG. 3 explains further details of the preferred embodiment according to the present invention (No. 1);

FIG. 4 explains further details of the preferred embodiment according to the present invention (No. 2);

FIG. 5 shows the principle of the configuration of an inter-controller SW device (LOS);

FIG. 6 exemplifies a more specific configuration of the preferred embodiment according to the present invention;

FIG. 7 shows the protocol architecture between a BSC and a BTS;

FIG. 8 shows a mapping method for traffic information;

FIG. 9 shows a mapping method for control information;

FIG. 10 explains the structure of an ATM cell (No. 1);

FIG. 11 explains the structure of the ATM cell (No. 2);

FIG. 12 shows a device process sequence in the inter-controller SW device according to the preferred embodiment of the present invention;

FIG. 13 shows a call establishment procedure of the inter-controller SW device;

FIG. 14 shows a specific example of the device process sequence at the time of call establishment;

FIG. 15 is a flowchart showing an LOS process according to the preferred embodiment of the present invention;

FIG. 16 shows the data flow in the LOS (No. 1);

FIG. 17 shows the data flow in the LOS (No. 2);

FIG. 18 shows the data flow in the LOS (No. 3);

FIG. 19 shows the data flow in the LOS (No. 4);

FIG. 20 explains the case where control information included in an ATM (AAL-TYPE 5) cell is transferred from the BSC to the LOS;

FIG. 21 shows the sequence explaining a call origination procedure of a mobile station;

FIG. 22 shows a call termination procedure of the mobile station;

FIG. 23 shows the sequence representing a further preferred embodiment of the call origination process on a mobile station side (No. 1);

FIG. 24 shows the further preferred embodiment of the call origination/termination process on the mobile station side (No. 2);

FIG. 25 explains the method assigning a BTS number;

FIG. 26 shows the sequence representing a hand-off process (No. 1);

FIG. 27 shows the sequence representing the hand-off process (No. 2);

FIG. 28 exemplifies the configuration of the LOS, and the like, when a composite cell is used;

FIG. 29 exemplifies the hardware configuration of the LOS;

FIG. 30 exemplifies the hardware configuration of the BSC;

FIG. 31 exemplifies the configuration in the case where the capabilities of the inter-controller SW device are incorporated into the BSC (No. 1);

FIG. 32 exemplifies the configuration in the case where the capabilities of the inter-controller SW device are incorporated into the BSC (No. 2);

FIG. 33 shows the sequence at the time of call establishment in the preferred embodiment shown in FIGS. 31 and 32; and

FIG. 34 shows a more specific sequence of the wireless access system.

### DESCRIPTION OF THE PREFERRED EMBODIMENTS

According to a preferred embodiment of the present invention, a simple switch device (an inter-controller SW device: location selector), which interconnects an arbitrary wireless BSC (Base Station Controller) and an arbitrary wireless BTS (Base station Transceiver Subsystem), is inserted between a wireless BSC and a wireless BTS in an existing fixed network wireless system (wireless local loop system). As a result, routing is always made from an MS (Mobile Station) to an LE (Local Exchange) to which the MS is registered as a subscriber in whichever BTS area the MS stays, so that it becomes possible to make the LE believe as if the communication were made to a fixed SU (Subscriber Unit), and to configure a simple and low-cost mobile communications system.

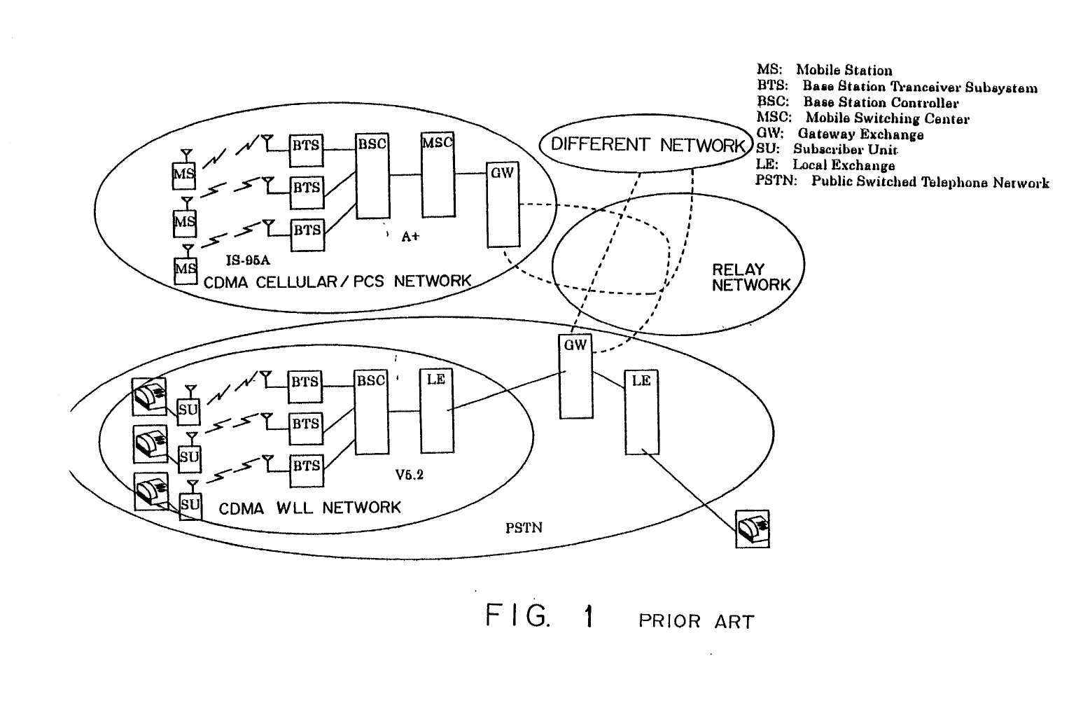

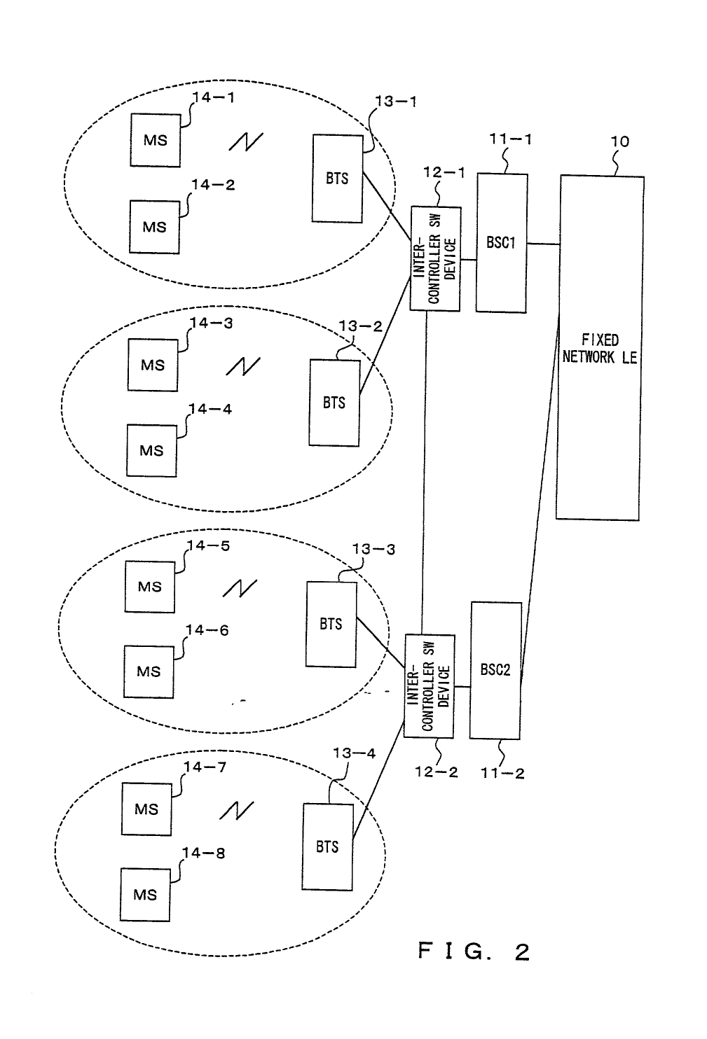

FIG. 2 shows the principle of the configuration of one preferred embodiment according to the present invention.

In this figure, 10 indicates a fixed network LE (Local Exchange), and 11-1 and 11-2 indicate wireless BSCs (Base Station Controllers) belonging to the fixed network LE. 12-1 and 12-2 indicate inter-controller (simple) switch devices (location selectors) that respectively belong to the wireless BSCs 11-1 and 11-2. 13-1 through 13-4 indicate wireless BTSs (Base station Transceiver Subsystems) belonging to the BSCs 11-1 and 11-2.

Here, assume that the BTSs 13-1 and 13-2, and the BTSs 13-3 and 13-4 are fixedly assigned to the BSCs 11-1 and 11-2 respectively as network resources.

14-1 through 14-8 indicate MSs (Mobile Stations) If viewed from the LE 10, the MSs 14-1 and 14-2 fixedly exist in the wireless area of the BTS 13-1 subordinate to the BSC 11-1. The other MSs are similar.

Additionally, each of ellipses represented by dotted lines indicates the wireless cell area covered by each of the BTSs 13-1 through 13-4.

Since the LE 10 does not comprise the capability for grasping the positional information of the MSs 14-1 through 14-8, for example, “a simultaneous calling signal”, which is transmitted from the LE 10 to the BSC 11-1 when a call is originated on the network side (when the call is terminated by an MS), is transmitted only to the BTS 13-3 and 13-4.

According to this preferred embodiment, the inter-controller SW devices (location selectors) route “the simultaneous calling signal” so as to broadcast the signal to all of the BTSs 13-1 through 13-4. As a result, “the simultaneous calling signal” reaches all of the BTSs, which simultaneously call the MSs within the wireless areas of the BTSs themselves.

A target MS (for example, 14-1) that receives “the simultaneous calling signal” transmits a call acknowledge (ACK) signal to the BTS having the wireless area in which the target MS itself stays. The BTS identifies the identification number of the MS from the received ACK signal, attaches a routing tag (destination information) specifying the BSC to which the MS originally belongs and is registered, and the identification number of the BTS itself to the ACK signal, and transmits the signal to its superordinate inter-controller SW device (location selector) 12-1.

The inter-controller SW device (location selector) 12-1 relays the ACK signal to the destination BSC 11-1 based on the routing tag attached to the received ACK signal.

The BSC 11-1 that receives the ACK signal manages the call number of the received ACK signal, and registers the call number and the identification number of the corresponding BTS to its internal memory. Thereafter, the BSC 11-1 attaches a routing tag for relaying the signal with this call number, for which the call process is to be performed, to the corresponding BTS (13-1 in this case), and transmits the signal to the inter-controller SW device (location selector) 12-1. The inter-controller SW device 12-1 routes the signal to the destination BTS 13-1 based on the routing tag.

If the MS 14-1 moves from the wireless area of the BTS 13-1 to that of another (for example, 13-3), the voice information transmitted from the MS 14-1 is received by the BTS 13-3. The BTS 13-3 attaches a routing tag specifying the destination BSC and the identification number of the BTS 13-3 itself to the information according to the identification number of the MS 14-1, and transmits the information to the inter-controller SW device (12-2).

The inter-controller SW device (12-2) routes this voice information to the destination BSC 11-1 based on the routing tag. The BSC 11-1 updates the identification number of the BTS, which corresponds to a call number, from 13-1 to 13-3 according to the identification number of the source BTS (13-3), which is attached to the received voice information. Thereafter, the BSC 11-1 attaches the routing tag specifying the destination BTS 13-3 to the voice information from the network side, and transmits the information to the inter-controller SW device 12-1.

By adding a simple switch device (inter-controller SW device) in an existing fixed network wireless system (wireless local loop system), voice and control information transmitted from an MS are always routed to an LE to which the MS belongs and is registered. As a result, a simple and low-cost mobile communications system can be configured.

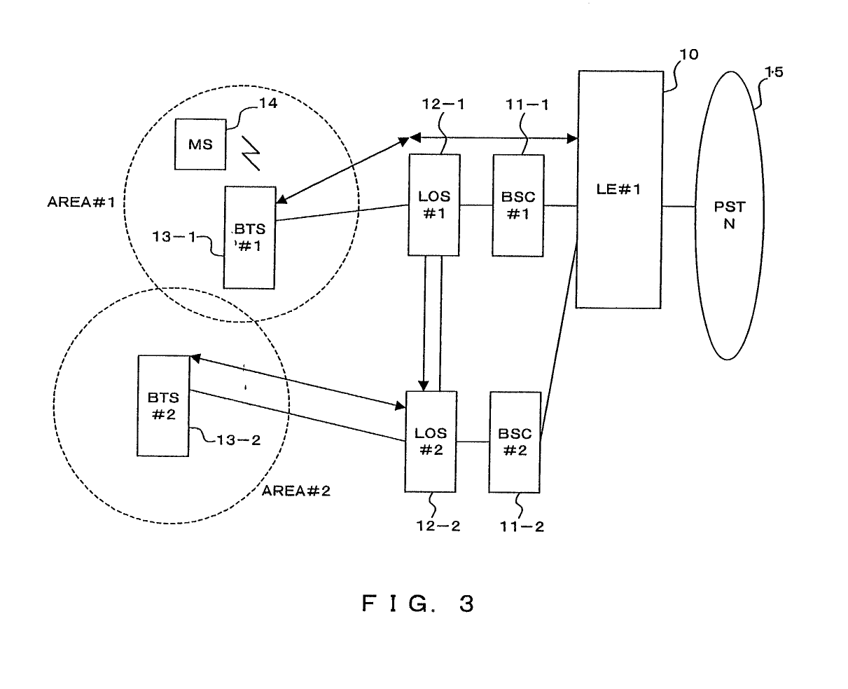

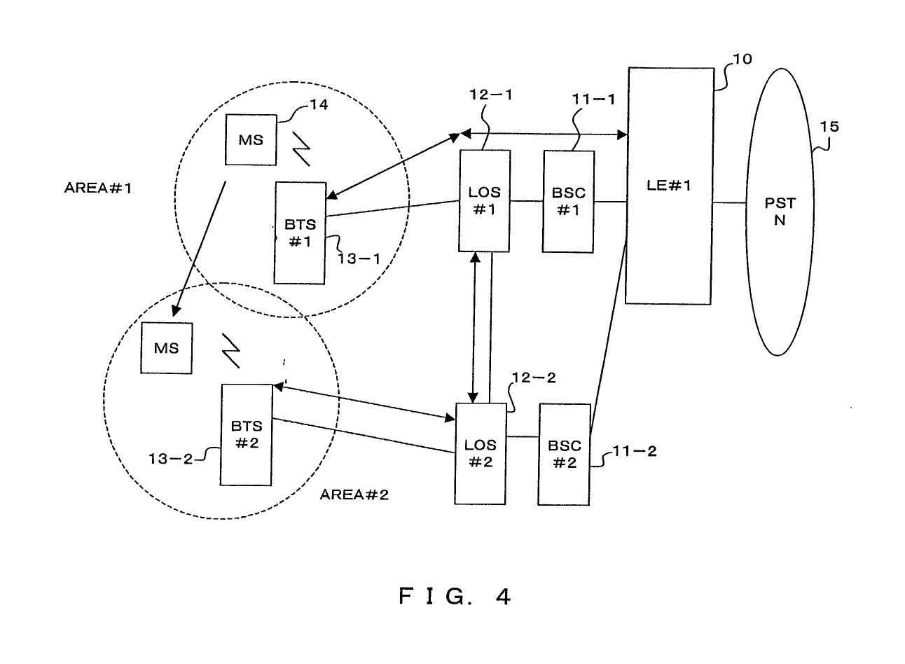

FIGS. 3 and 4 explain further details of the preferred embodiment according to the present invention.

Here, 15 indicates a PSTN (Public Switched Telephone Network). 10 indicates a fixed network LE (Local Exchange). 11-1 and 11-2 indicate a BSC #1 and a BSC #2 (wireless Base Station Controllers) belonging to the LE 10. 12-1 and 12-2 indicate an LOS #1 and an LOS #2 (inter-controller SW devices), which respectively belong to the BSC #1 (11-1) and the BSC #2 (11-2). 13-1 and 13-2 indicate a BTS #1 and a BTS #2 (wireless base station devices). 14 indicates an MS (mobile station). Ellipses represented by dotted lines indicate an AREA #1 and an AREA #2, which are respectively covered by the BTS #1 and the BTS #2.

Here, the MS 14 is always identified by the LE 10 as a fixed station that resides in the area of the BTS #1 (13-1) subordinate to the BSC #1 (11-1).

FIG. 3 shows the path of voice and control information of the MS 14 staying in the AREA #1, whereas FIG. 4 shows the path of voice and control information when the MS 14 moves from the AREA #1 to the AREA #2.

The voice and the control information are converted into an ATM cell format that can be routed at high speed, and transmitted/received between a BTS, an LOS, and a BSC.

The voice path establishment shown in FIG. 3 is described below.

Upstream voice and control information from the MS 14 are transmitted to the BTS #1 (13-1) via the wireless area. The BTS #1 searches for a destination BSC that is fixedly determined from the MSIN (an MS identifier managed in this system) of the MS 14, which is obtained in the call origination/termination process, and attaches the number of the destination BSC to the VCI/VPI within the header of an ATM cell as routing information (or a tag) by coding the number, and transmits the cell to the LOS #1 (12-1).

The LOS #1 (12-1) selects the path for the destination BSC based on the VCI/VPI within the header of the ATM cell, and transmits the ATM cell to the BSC #1 (11-1) being the destination BSC after changing the VCI/VPI to the identification number (defined in the system) of the source BTS immediately before the transmission.

The BSC #1 (11-1) identifies the source BTS based on the VCI/VPI of the received cell, and registers the identification number of the BTS in units of call numbers assigned to the voice and control information exchanged by this ATM cell.

The BSC #1 (11-1) extracts the voice and control information from the payload of the received ATM cell, converts the extracted information into the format and the protocol of the LE side, and transmits the voice and control signals to the LE side.

The LE 10 terminates the received control information, and transmits the voice information to the PSTN 15.

Downstream voice and control information from the LE 10 are format- and protocol-converted, and then, the converted information are encapsulated into an ATM cell. The voice and the control information encapsulated into the ATM cell are coded to the VCI/VPI, and transmitted to the LOS #1 (12-1).

The LOS #1 selects a path based on the identification number of the destination BTS of the received ATM cell, and relays the ATM cell to the destination BTS (the BTS #1 (13-1)).

After the BTS #1 (13-1) extracts the voice and control information from the payload of the received ATM cell, and converts the extracted information into the format and the protocol of the wireless signal side, it transmits the converted signal to the wireless area. The MS 14 then picks up the voice and control information addressed to the MS 14 itself.

In the case shown in FIG. 4, the MS 14 moves to the AREA #2 of the BTS #2 (13-2). Since the MS 14 originally belongs and is registered to the BSC #1 (11-1) as shown in FIG. 3, the inter-controller SW device routes the voice information of the MS 14 to the BSC #1 to which the MS 14 belongs. The voice and control information transmitted from the MS 14 are received by the BTS #2 (13-2) via the wireless area. The BTS #2 (13-2) encapsulates the received voice and control information into an ATM cell, and transmits the ATM cell to the inter-controller SW device LOS #2 (12-2). At this time, the inter-controller SW device LOS #2 (12-2) routes the voice information to the other LOS device (LOS #1 (12-1)), which becomes a path to the BSC, by detecting the VCI/VPI within the header of the received ATM cell. At this time, the LOS #1 detects the VCI/VPI within the header of the received ATM cell, and routes the ATM cell to the BSC #1 (11-1). The BSC #1 (11-1) that receives the ATM cell terminates the ATM cell if it is a cell addressed to the BSC #1 itself, puts the cell into a PCM signal, and transmits the signal to the LE 10.

Inversely, for the downstream voice and control information, the voice information transmitted from the LE 10 is transmitted to the BSC #1 (11-1), put into an ATM cell, and transmitted to the LOS #1 (12-1). The LOS #1 (12-1) transmits the received voice information to the BTS #1 (13-1), copies the information in its internal memory, and transmits this information to the LOS #2 (12-2). The LOS #2 (12-2) that receives the voice information transmits the voice information to the BTS #2 (13-2) subordinate to the LOS #2 itself. The BTS #1 (13-1) and the BTS #2 (13-2) that receive the voice information wirelessly transmit the voice information to the AREA #1 and the AREA #2 of the BTSs themselves. The MS 14 receives the voice information that is wirelessly transmitted to the AREA #2.

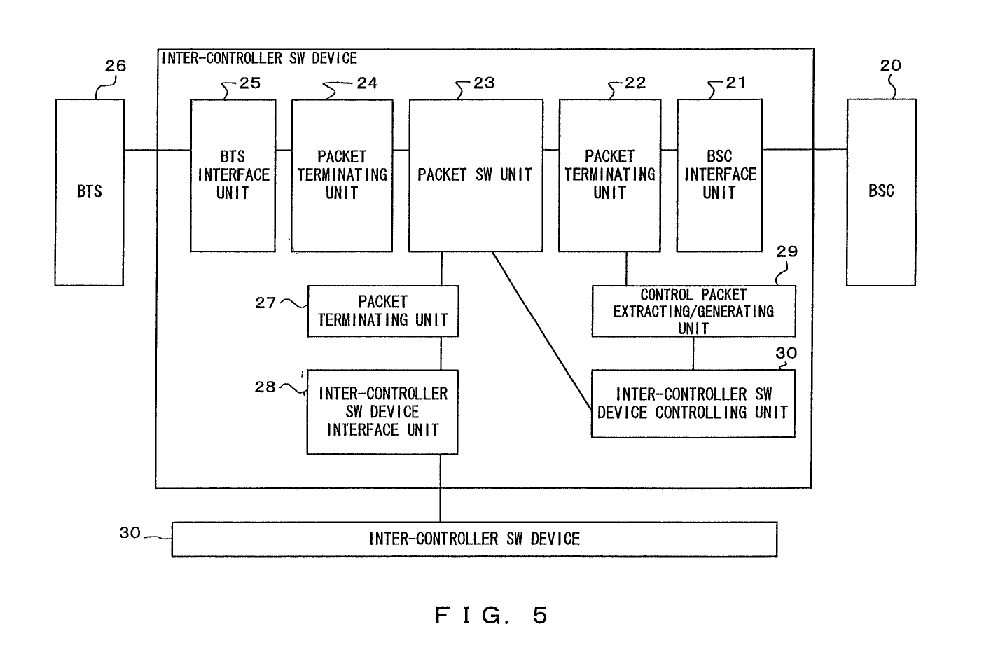

FIG. 5 shows the principle of the configuration of an inter-controller SW device (LOS).

Here, 20 indicates a wireless BSC (Base Station Controller), and 21 indicates a BSC interface unit. 22 indicates a packet terminating unit. 29 indicates a unit extracting/generating a control packet transmitted/received to/from the BSC 20. 30 indicates an inter-controller SW device controlling unit controlling and monitoring the whole of the inter-controller SW device. 23 indicates a packet SW unit switching the packet received by the inter-controller SW device. 24 indicates a packet terminating unit terminating the packet switched by the packet SW unit 23. 25 indicates an interface unit with a BTS. 26 indicates the BTS. Also 27 is a packet terminating unit. 28 indicates a different inter-controller SW device interface unit. 31 indicates a different inter-controller SW device.

The control information transmitted as a packet from the BSC 20 is terminated by the packet terminating unit 22 via the BSC interface unit 21. If the control information packet is addressed from the BSC 20 to the inter-controller SW device itself, the control packet extracting/generating unit 29 extracts the control information, and passes the extracted information to the inter-controller SW device controlling unit 30.

The inter-controller SW device controlling unit 30 controls the routing of cells of the packet SW unit 23 according to received control information.

Here, the process for voice information from the wireless BSC 20 to the direction of the wireless BTS 26 is explained. A voice information cell transmitted as a packet from the wireless BSC 20 is terminated by the packet terminating unit 22 via the BSC interface unit 21 similar to an information cell, and transmitted to the packet SW unit 23. The packet SW unit 23 copies the received voice information cell, and transmits the cells to the packet terminating unit 24 (on the wireless BTS side) and the packet terminating unit 27 (on the different inter-controller SW device side).

The packet terminating unit 24 (on the wireless BTS side) generates a packet in the format of the BTS, and transmits the voice information to the wireless BTS 26 via the BTS interface unit 25. In the meantime, the packet terminating unit 27 (on the different inter-controller SW device side) that receives the copied voice information cell attaches destination information specifying the wireless BTS side, generates a packet in the format of the inter-controller SW device, and transmits the packet to the different inter-controller SW device 31 via the different inter-controller SW device interface unit 28.

The reverse process for voice information from the direction of the BTS 26 to the BSC 20 is explained next. A voice information cell transmitted as a packet from the BTS 26 is terminated by the packet terminating unit 24 via the BTS interface unit 25, and transmitted to the packet SW unit 23. The packet SW unit 23 examines the destination number of the received voice information cell. If the destination number is the number of the BSC to which the inter-controller SW device itself belongs, the packet SW unit 23 transmits the voice information cell to the BSC 20 via the packet terminating unit 22 and the BSC interface unit 21. If the destination number is not the number of the BSC to which the inter-controller SW device itself belongs, the packet SW unit 23 transmits the voice information cell to the different inter-controller SW device 31 via the packet terminating unit 27 (on the different inter-controller SW device side) and the different inter-controller SW device interface unit 28.

The voice information cell received from the different inter-controller SW device 31 is transmitted to the packet SW unit 23 via the different inter-controller SW device interface unit 28 and the packet terminating unit 27 (on the different inter-controller SW device side). The packet SW unit 23 examines the destination number of the received voice information cell, and determines whether the cell is directed either to the BTS 26 or to the BSC 20. If the destination number is directed to the BTS 26, the packet SW unit 23 copies the voice information cell, and transmits the cells to the packet terminating unit 24 (on the BTS side) and the packet terminating unit 27 (on the different inter-controller SW device side). The packet terminating unit 24 (on the BTS side) generates a packet in the format of the BTS, and transmits the voice information to the BTS 26 via the BTS interface unit 25. If the voice information cell is directed to the BSC 20, and if the destination number is the number of the BSC to which the inter-controller SW device itself belongs, the packet SW unit 23 transmits the voice information cell to the BSC 20 via the packet terminating unit 22 (on the BSC side) and the BSC interface unit 21. Additionally, if the destination number is not the number of the BSC to which the inter-controller SW device itself belongs, the packet switch unit 23 transmits this cell to the different inter-controller SW device 31 via the packet terminating unit 24 (on the BTS side), the packet terminating unit 27 (on the different inter-controller SW device side), and the different inter-controller SW device interface unit 28.

By adding a device comprising the packet routing capability to an existing fixed network wireless system (fixed network exchange), a signal transmitted from an MS is always routed to a fixed network exchange to which the MS belongs. As a result, a simple and low-cost mobile communications system can be configured.

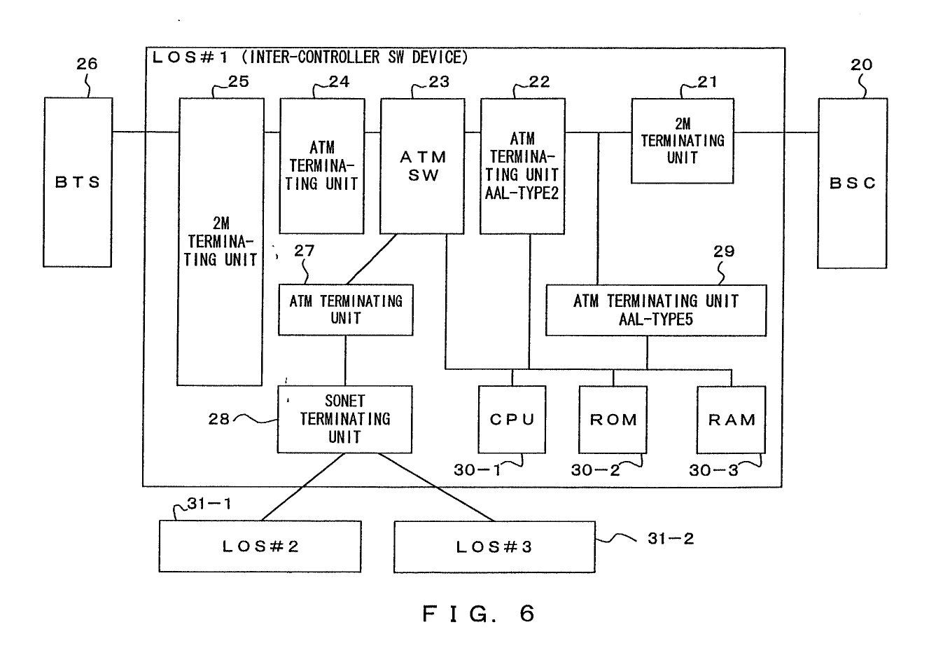

FIG. 6 exemplifies a more specific configuration of the preferred embodiment according to the present invention.

In this figure, voice and control packets exchanged between a BTS and a BSC are transmitted in the form of ATM cells.

Here, 20 indicates a BSC (wireless base station controller), and 21 indicates a 2M terminating unit (particularly referred to as a 2M terminating unit in this example, since a line between an LOS and the BSC, or between the LOS and the BTS is 2 Mbps). 22 indicates an ATM terminating unit (AAL-TYPE 2) which terminates an ATM cell being a voice information cell. 27 indicates an ATM (AAL-TYPE 5) layer terminating unit which terminates an ATM cell being a control information cell transmitted/received to/from the BSC. 30-1 through 30-3 indicate an inter-controller SW device controlling unit, which is configured by a CPU 30-1, a ROM 30-2, and a RAM 30-3. 23 indicates an ATM SW unit that switches an ATM cell received by the inter-controller SW device at high speed. 24 indicates a terminating unit terminating an ATM cell transmitted/received to/from the BTS. 25 indicates a unit terminating a 2M communications line between the BTS and the inter-controller SW device. 26 indicates the BTS. 27 indicates an ATM terminating unit terminating an ATM cell transmitted/received to/from a different inter-controller SW device. 28 indicates a SONET terminating unit terminating a SONET protocol being an optical interface with a different LOS. 31-1 and 31-2 respectively indicate an LOS #2 and an LOS #3.

An ATM cell transmitted as a 2M line ATM cell from the BSC 20 is terminated by the ATM terminating unit 22 via the 2M terminating unit 21. If the VCI/VPI value within the header of the ATM (AAL-TYPE 5) cell indicates the LOS #1 as a destination, this cell is terminated by the ATM terminating unit (AAL-TYPE 5) 27. Then, control information is extracted, and passed to the LOS controlling unit (configured by the CPU, the ROM, and the RAM) 30-1 through 30-3. The LOS controlling unit (configured by) 30-1 through 30-3 controls the cell routing of the ATM SW unit 23 according to received control information.

The process for voice information from the BSC 20 to the direction of the BTS 26 is explained. A voice information cell transmitted as an ATM (AAL-TYPE 2) cell from the BSC 20 is terminated by the ATM terminating unit 22 via the 2M terminating unit 21, and transmitted to the ATM SW unit 23. The ATM SW unit 23 copies the received ATM (AAL-TYPE 2) cell, and transmits the cells to the ATM terminating unit 24 (on the BTS side) and the ATM terminating unit 27 (on the different LOS side) The ATM terminating unit 24 (on the BTS side) generates a packet in the format of the BTS, and transmits the voice information to the BTS 26 at 2 Mbps (ATM). The ATM terminating unit 27 (on the different LOS side) sets the VCI/VPI value indicating the BTS side as a destination, and transmits the cell to the LOS 32 (31-1) and the LOS #3 (31-2) via the ATM and the SONET terminating units 27 and 28.

The reverse process for voice information from the direction of the BTS 26 to the BSC 20 is explained below. A voice information cell transmitted as an ATM (AAL-CU) cell from the BTS 26 is terminated by the 2M terminating unit 25 and the ATM (AAL-CU) terminating unit 24, and transmitted to the ATM SW unit 23. The ATM SW unit 23 examines the VCI/VPI value within the header of the received ATM cell. If the VPI/VCI value is the value of the BSC 20 to which the LOS #1 itself belongs, the ATM terminating unit 22 (on the BSC side) generates an ATM (AAL-TYPE2) cell, which is a composite cell and an existing BTS-BSC interface, and transmits the voice information cell to the BSC 20 via the 2M terminating unit 21. If the VPI/VCI value is not the value of the BSC 20 to which the LOS #1 itself belongs, the ATM switch unit 23 transmits the cell to the LOS #2 (31-1) and the LOS #3 (31-2) via the ATM terminating unit 27 (on the different LOS side) and the 2M terminating unit 28.

The ATM (AAL-CU) cell received from the LOS #2 (31-1) via the optical interface is transmitted to the ATM SW unit 23 via the SONET terminating unit 28 and the ATM terminating unit (on the different LOS side). The ATM SW unit 23 examines the VCI/VPI value of the received ATM (AAL-TYPE 2) cell, and determines whether the cell is directed either to the BTS 26 or to the BSC 20. If the cell is directed to the BTS 26, the ATM SW unit 23 copies the ATM cell, and transmits the cells to the ATM terminating unit 24 (on the BTS side) and the 2M terminating unit 26 (on the BTS side). The ATM terminating unit 24 (on the BTS side) generates an ATM (AAL-TYPE CU) cell, and transmits the voice information cell to the BTS26 via the 2M terminating unit 25. The ATM terminating unit 27 (on the different LOS side) that receives the copied ATM cell generates an ATM cell in the format of the LOS, and transmits the generated cell to the LOS #2 (31-1) via the SONET terminating unit 28. If the cell is directed to the BSC 20, and if the VCI/VPI value within the header of the ATM cell is the number of the BSC to which the LOS #1 itself belongs, the voice information cell is transmitted to the BSC 20 via the ATM terminating unit 22 (on the BSC side), and the 2M terminating unit 21. If the VCI/VPI value within the header of the ATM cell is not the number of the BSC to which the LOS #1 itself belongs, the voice information cell is transmitted to the LOS #3 (31-2) via the ATM terminating unit 27 (on the different LOS side) and the 2M terminating unit 28.

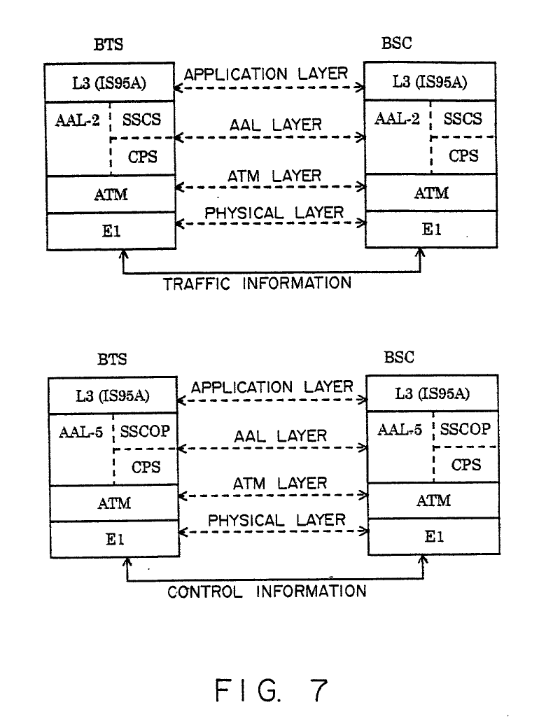

FIG. 7 shows the protocol architecture between the BSC and the BTS.

An ATM layer exists above a physical layer, an AAL layer exists above the ATM layer, and an application layer exists above the AAL layer. The physical layer uses E1. The AAL layer uses AAL-2 for a traffic information transfer, and AAL-5 for a control information transfer.

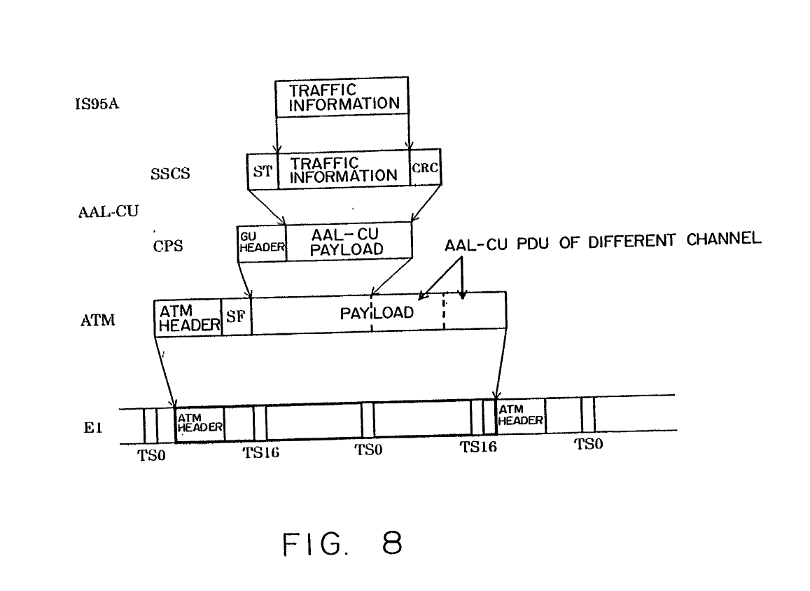

FIG. 8 shows a mapping method for traffic information.

Traffic information is structured as an AAL-CU packet in an AAL-CU layer, and buried in the payload of an ATM cell. This ATM cell is transferred in an E1 format.

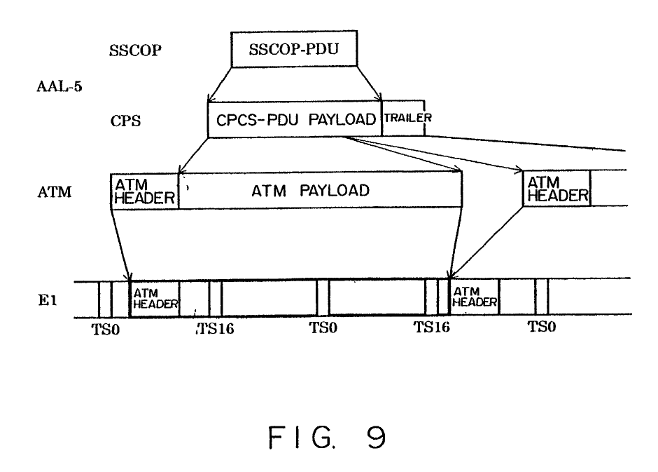

FIG. 9 shows a mapping method for control information.

Control information is included in an SSCOP-PDU, structured as a CPS-PDU in an AAL-50, and buried in the payload of an ATM cell. Since control information is not normally included in the payload of one ATM cell, the information is mapped onto a plurality of ATM cells. Then, the ATM cells are structured in the E1 format in the physical layer, and transmitted.

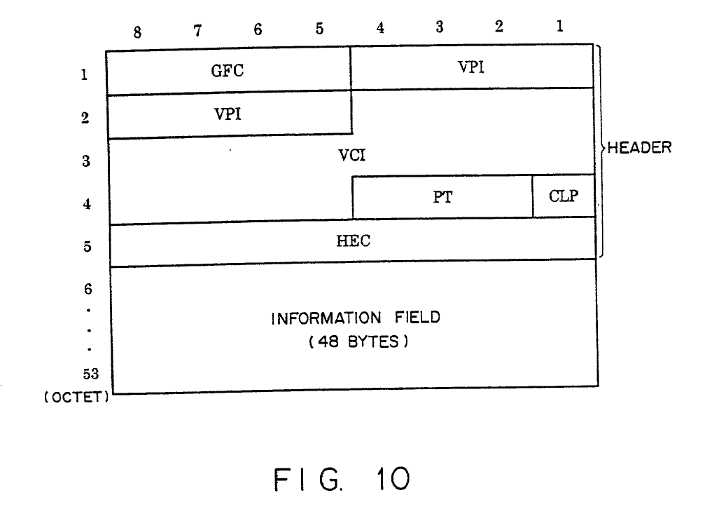

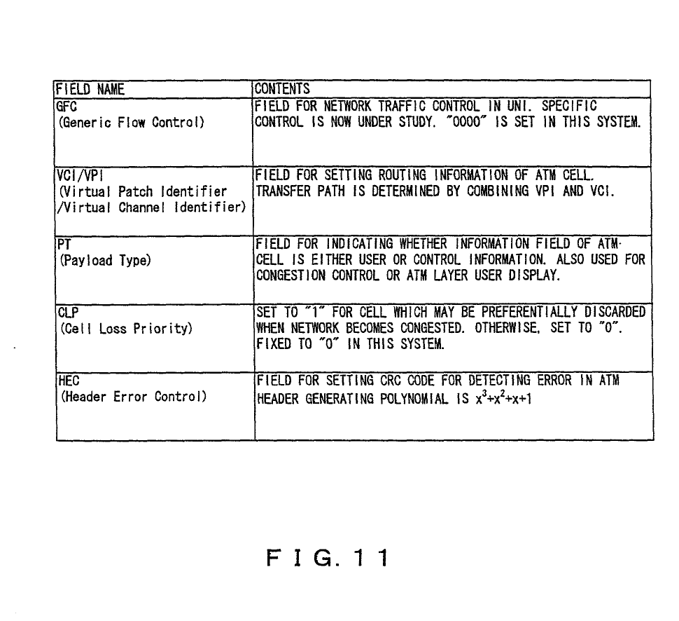

FIGS. 10 and 11 explain the structure of an ATM cell.

The ATM cell is composed of a header and a payload being an information field, and has a fixed-length. Contents of respective fields included in the header of the ATM cell are shown in FIG. 11. Here, the VCI/VPI utilized in this preferred embodiment is normally used to specify a transfer destination in an ATM cell. By examining this value, to which BTS a signal from a BSC is to be transferred, etc. is determined by an LOS. Or, as another method, the VCI/VPI is referenced, and a tag indicating a destination number is attached to an ATM cell within an LOS, so that switching is made based on the tag.

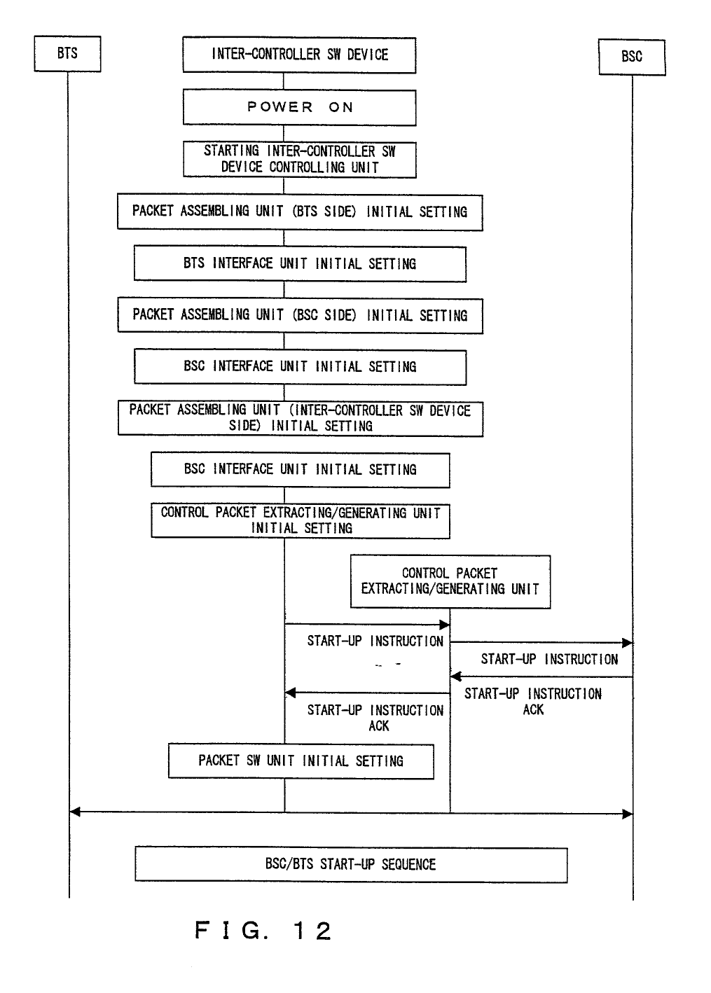

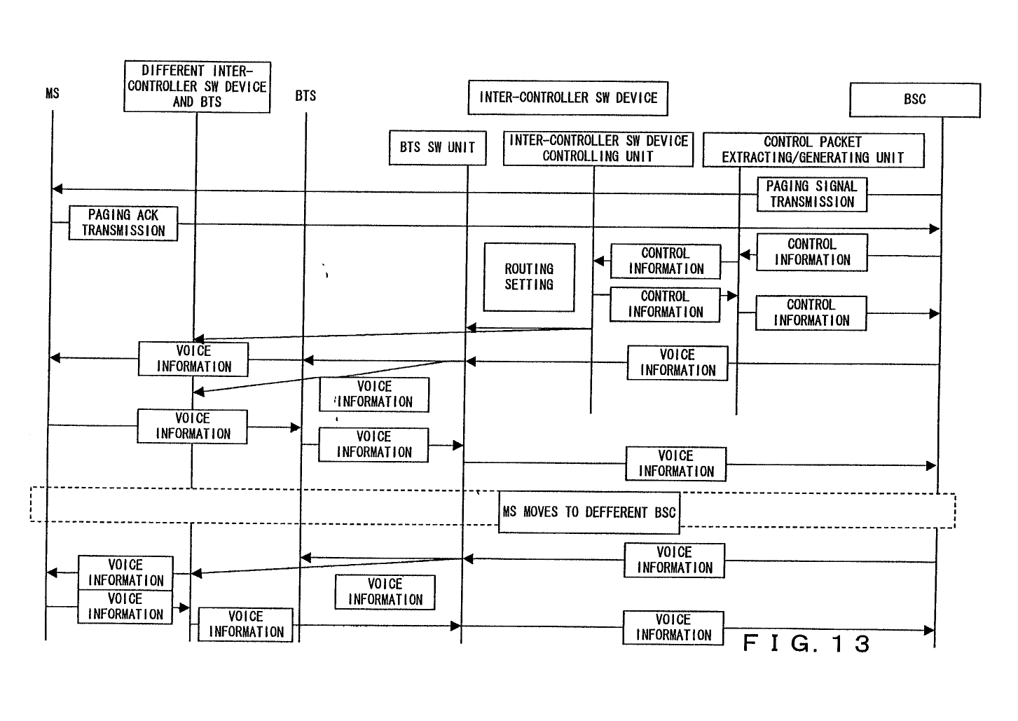

FIG. 12 shows a device process sequence of the inter-controller SW device according to the preferred embodiment of the present invention, whereas FIG. 13 shows a call establishment procedure of the inter-controller SW device.

Once the inter-controller SW device is started up in FIG. 12, the inter-controller SW device controlling unit makes initial settings for the BTS, the BSC, the different inter-controller SW device interface unit, and the packet assembling unit. Then, the inter-controller SW device makes initial setting for the control packet extracting/generating unit.

Next, the inter-controller SW device controlling unit makes cell routing setting as the initial setting of the packet SW unit (the cell routing setting at this time is through setting that does not consider an interface with a different inter-controller SW device. Namely, cell routing is made to a BTS belonging to a BSC). After the inter-controller SW device controlling unit generates a packet signal for requesting the start-up of the BSC in the control packet extracting/generating unit, it transmits the signal via the BTS interface unit and a packet assembling unit. The BSC that receives the packet signal for requesting the start-up returns a start-up request acknowledge signal to the inter-controller SW device controlling unit. At this time, the information of the BTS belonging to the BSC, etc. is attached to the start-up request acknowledge signal. Then, the start-up sequence for the existing BSC and BTS is performed by passing through the inter-controller SW device.

Additionally, in FIG. 13 (the device process sequence at the time of call establishment), the BSC #1 transmits a synchronization (paging) signal to all of MSs via the inter-controller SW device (LOS #1) and the BTS #1. The MSs that receive the paging signal transmit a paging ACK signal to the BTS. At this time, the BSC #1 transmits control information (AAL-TYPE 5) including routing information to the inter-controller SW device (LOS #1). This control information is received by the inter-controller SW device controlling unit (the CPU of the LOS device) via the control packet extracting/generating unit.

According to this routing information, the inter-controller SW device controlling unit (the CPU of the LOS device) makes routing settings for the ATM SW unit. The inter-controller SW device controlling unit makes similar routing settings also for a different inter-controller SW device (LOS #2, etc.). In this way, a hardware path between the MS and the BSC #1 is secured. Downstream voice information (from the BSC to the MS) is transmitted from the BSC to the BTS, and copied and transmitted to the different inter-controller SW device (LOS) side by the ATM SW unit, so that the voice information is transmitted to all of the MSs in a broadcast-like manner. Inversely, an MS number is assigned by the BTS to the voice information transmitted from the MS, and the information is received by the inter-controller SW device. At this time, the voice information is received by the ATM SW unit. If the assigned MS number matches the routing information set as described above, the voice information is transmitted to the BSC.

If the MS moves to the area subordinate to a different BSC, downstream (from the BSC to the MS) voice information is transmitted by the ATM SW unit from the BSC to the BTS #1, and copied and transmitted to the side of the different inter-controller SW device (LOS #2), so that the voice information is transmitted to all of the MSs in a broadcast-like manner. Inversely, upstream (from the MS to the BSC) voice information transmitted from the MS is assigned an MS number by the BTS #2, and received on the side of the inter-controller SW device (LOS #2). At this time, the voice information is received by the ATM SW unit. Because the assigned MS number does not match the routing information set as described above (this inter-controller SW device (LOS #2) cannot process the MS), the voice information is transmitted to the side of the different inter-controller SW device (the LOS #1). On the side of the different inter-controller SW device (the LOS #1: the device which becomes responsible for processing the MS in the initial negotiation), the MS number assigned to the received voice information matches the routing information set as described above. Therefore, the voice information is transmitted to the BTS #1.

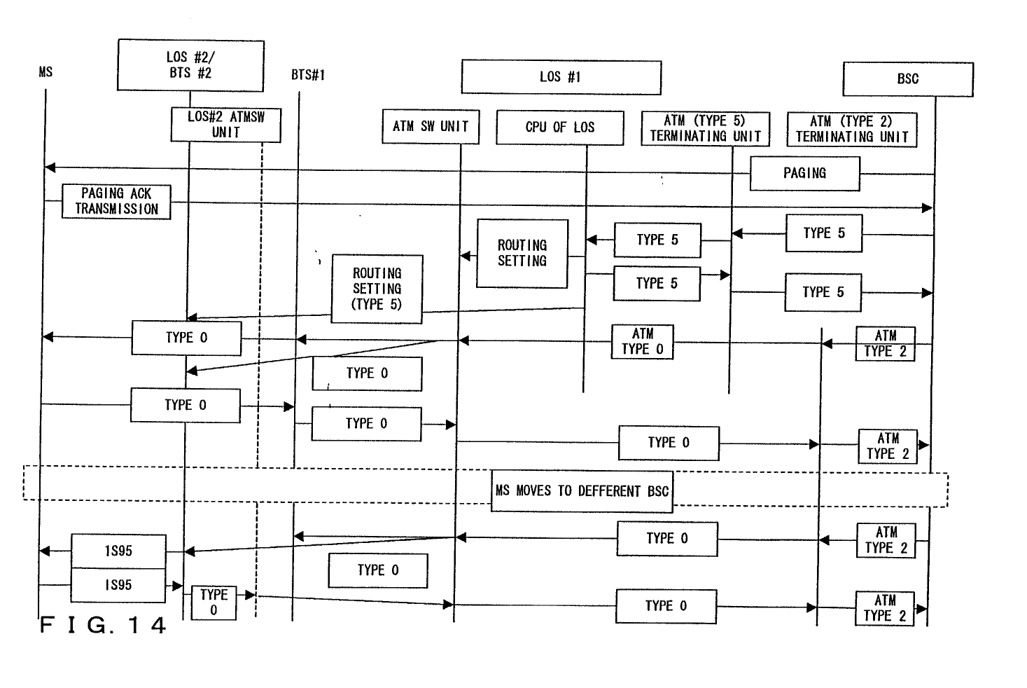

FIG. 14 shows a specific example of the device process sequence at the time of call establishment.

The BSC #1 transmits a paging signal (PAGING CH) to all of its subordinate BTSs. An MS that receives the paging signal transmits an ACK signal to the corresponding BTS. According to this ACK signal, the BSC identifies the MS (MS number: 001) as a station that becomes subordinate to the BSC itself. The BSC notifies the LOS with an ATM cell (AAL-TYPE 5: control information) via a 2M line that the MS (the MS number: 001) belongs to the BSC. The ATM (AAL-TYPE 5:control information) cell is terminated by the 2M terminating unit and the ATM (AAL-TYPE 5) terminating unit, and identified by the CPU of the LOS #1. The CPU makes routing settings for the ATM SW unit via a CPU bus so that an upstream channel from the MS (the MS number: 001) is routed to the BSC#1 (the VCI/VPI setting of an ATM cell: 00/0001). Additionally, the CPU makes routing settings for the ATM SW unit of the LOS#2 and the LOS#3 via the ATM (AAL-TYPE5) terminating unit, the ATM (AAL-TYPE 2) terminating unit, the ATM SWVCI/VPI, the ATM (AAL-TYPE 2) terminating unit, and the SONET terminating unit (a cell from the MS having the MS number 001 is set to be routed to the BSC#1).

In this way, a hardware path between the MS and the BSC #1 is secured. Downstream (from the BSC #1 to the MS) voice information (ATM AAL-TYPE 2 cell) is received by the 2M terminating unit. This composite cell is disassembled and put into an ATM cell (AAL-TYPE 0 VCI/VPI: 00/0001). The ATM SW unit transmits this cell to the BTS, and copies the cell and transmits the copied cells to the LOS #2 and the LOS #3, so that the voice information is transmitted to all of the MSs in a broadcast-like manner. Inversely, upstream (from the MS to the BSC #1) voice information transmitted from the MS is put into an ATM cell (AAL-TYPE 0 VCI/VPI: 00/0001) by the corresponding BTS, and received by the LOS #1. At this time, the ATM (AAL-TYPE 0) cell is received by the ATM SW unit. If the cell having the VCI/VPI 00/0001 is received, this cell is converted into a TYPE 2 cell by the ATM (AAL-TYPE 2) terminating unit, that is, the cell is compressed to the data that is received from the LOS #2/the LOS #3 and addressed to the BSC #1, and transmitted to the BSC #1 via the 2M terminating unit.

If the MS moves to the area of the BTS #2, downstream (from the BSC #1 to the MS) voice information (ATM AAL-TYPE 2 cell) is received by the 2M terminating unit. This composite cell is disassembled, and put into an ATM cell (AAL-TYPE 0 VCI/VPI: 00/0001). The ATM SW unit transmits this ATM cell to the BTS, and copies the cell and transmits the copied cells to the LOS #2 and the LOS #3, so that the voice information is simultaneously transmitted to all of the MSs in a broadcast-like manner (in this case, the MS which moves to the area of the BTS #2 can receive the voice information). Inversely, upstream (from the MS to the BSC #1) voice information transmitted from the MS is put into an ATM cell (AAL-TYPE 0 VCI/VPI: 00/0001) by the BTS #2, and received by the LOS #2. At this time, the ATM (AAL-TYPE 0) cell is received by the ATM SW unit of the LOS #2. If the cell having the VCI/VPI 00/0001 is received, it is transmitted to the LOS #1. The LOS #1 that receives the AAL-TYPE 0 cell having the VCI/VPI 00/0001 puts it into a composite cell in the ATM (AAL-TYPE 2) terminating unit via the SONET terminating unit, the ATM (AAL-TYPE 0) terminating unit, and the ATM SW unit, and transmits the composite cell to the BSC #1 via the 2M terminating unit.

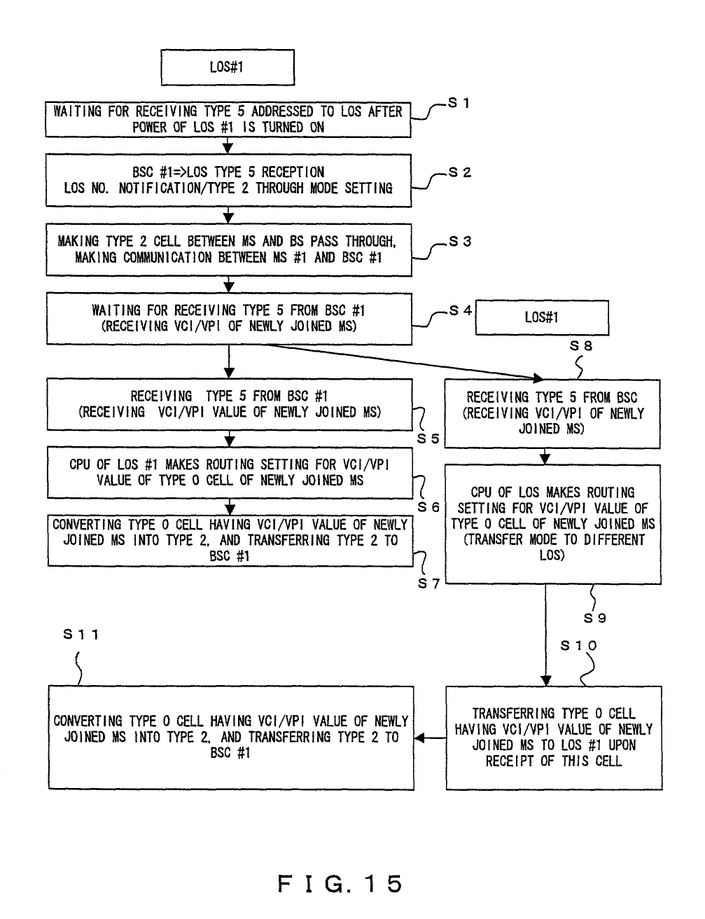

FIG. 15 is a flowchart showing the process of the LOS in the preferred embodiment according to the present invention.

After the power of the LOS #1 is turned on in step S1, it enters a state of waiting for the reception of a TYPE 5 cell addressed to the LOS. Upon receipt of the TYPE 5 cell from the BSC #1, the LOS notifies the number of the LOS itself, and makes a TYPE 2 cell pass through in step S2. In step S3, the LOS makes the TYPE 2 cell between the MS and the BSC pass through, so that a communication between the MS and the BSC is made. In step S4, the LOS waits for the reception of the TYPE 5 cell from the BSC #1. Namely, a cell from a new MS subordinate to the BSC is waited for. In step S5, the LOS receives the TYPE 5 cell from the BSC #1, namely, the cell having the VCI/VPI value of the newly joined MS. At this time, also the different LOS #2 receives the TYPE 5 cell from the BSC, namely, the cell having the VCI/VPI value of the newly joined MS in a similar manner as in step S8. In step S6, the CPU of the LOS #1 makes routing setting for the VCI/VPI value of the TYPE 0 cell of the newly joined MS. Similarly, in step S9, the CPU of the LOS #2 makes routing setting for the VCI/VPI value of the TYPE 0 cell of the newly joined MS. Here, the LOS #1 sets also a transfer mode to a different LOS. That is, the LOS #1 transfers the TYPE 0 cell received via the subordinate BTS to the BSC by making the cell pass through the LOS itself. Inversely, the LOS #1 makes settings in order to copy the cell transmitted from the BSC for a plurality of BTSs, and to transmit the copied cells to the BTSs.

Then, the LOS #1 converts the TYPE 0 cell having the VCI/VPI value of the newly joined MS into a TYPE 2 cell, and transfers the converted cell to the BSC #1. In the meantime, the LOS #2 transfers to the LOS #1 the TYPE 0 cell having the VCI/VPI value of the newly joined MS upon receipt of this cell in step S10. The LOS #1 converts the TYPE 0 cell having the VCI/VPI value of the newly joined MS into a TYPE 2 cell, and transfers the converted cell to the BSC #1 in step S11.

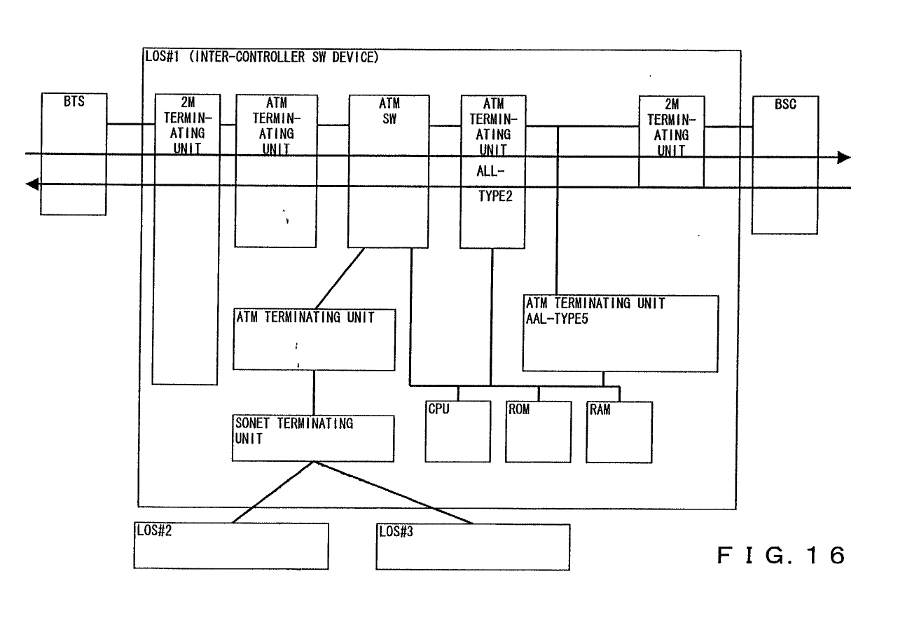

FIGS. 16 through 19 show the data flow in the LOS.

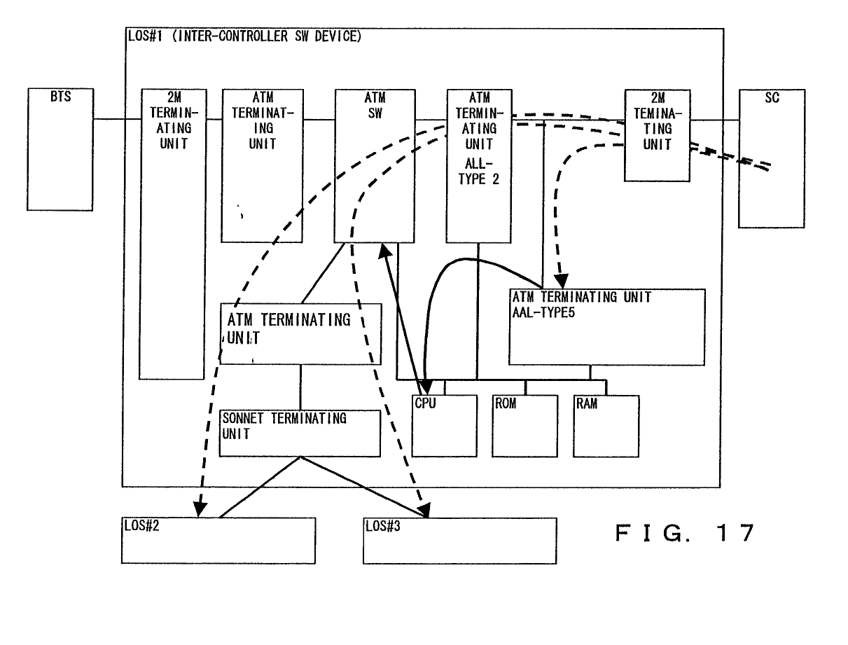

In FIG. 16, the LOS makes the position registration information and an ACK signal, which are transmitted from an MS, pass through. In the meantime, as shown in FIG. 17, the LOS receives the TYPE 5 cell from the BSC in its terminating unit, and makes routing settings for the ATM SW unit. At this time, the BSC establishes also paths to the LOS #1 and the LOS #2 with the TYPE 5 cell. In FIG. 17, dotted lines represent the flow of the TYPE 5 cell.

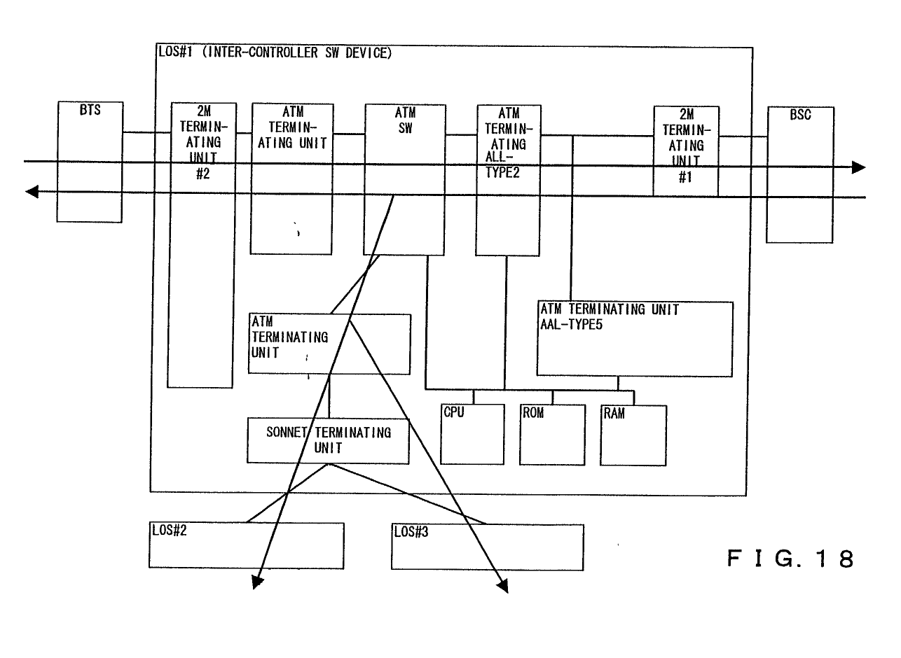

In FIG. 18, if an MS is subordinate to the BTS, a voice information (TYPE 2) cell goes along the paths shown in this figure. The TYPE 2 cell is disassembled into a TYPE 0 cell by the 2M terminating unit #2, and routed by the ATM SW unit. A downstream (from the BSC to the BTS) cell is transmitted in a broadcast-like manner.

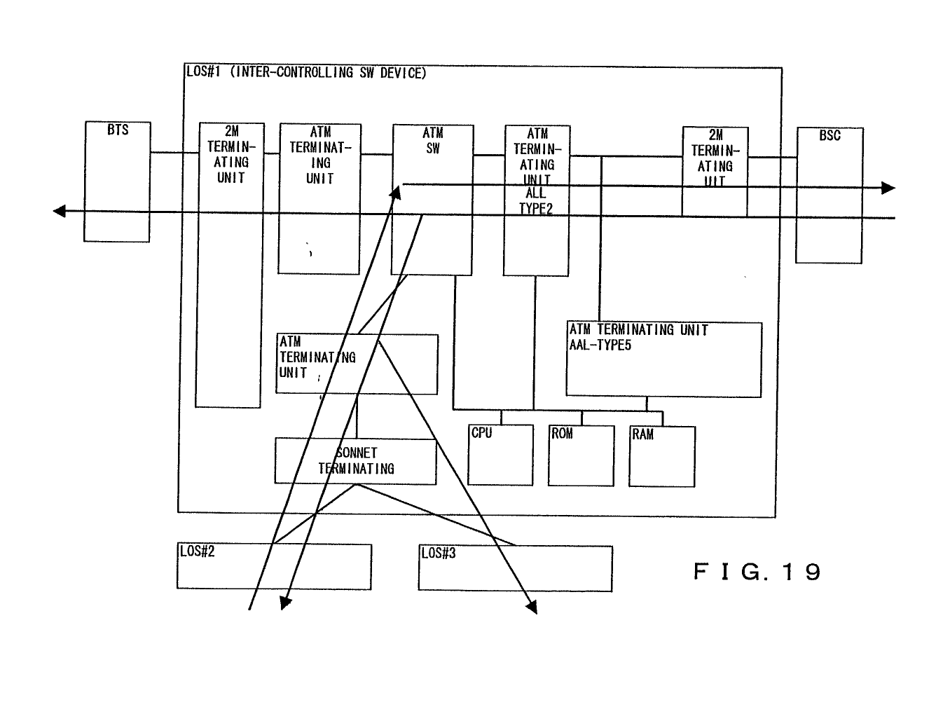

In FIG. 19, if an MS becomes subordinate to the LOS #2, a voice information (TYPE 2) cell goes along the paths shown in this figure. A downstream (from the BSC to the BTS) cell is transmitted in a broadcast-like manner.

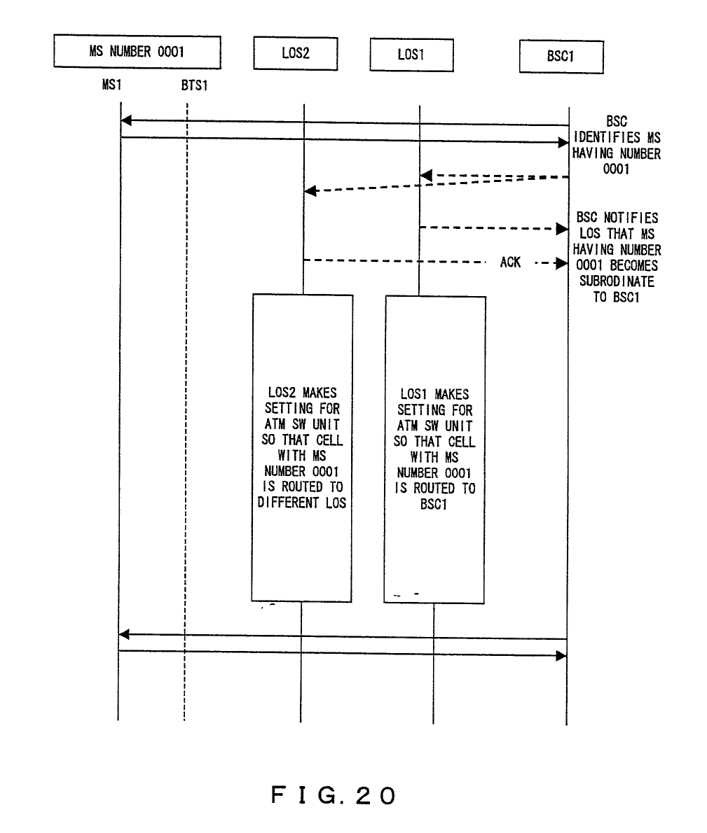

FIG. 20 explains the case where control information included in an ATM (AAL-TYPE 5) cell is transferred from the BSC to the LOS.

If the LOS can change routing information according to an instruction from the BSC, control information transmitted from the BSC to the LOS becomes the routing information of an ATM cell addressed to the LOS. If a control information cell is transmitted to the LOS subordinate to the BSC, the BSC identifies the MS that belongs to the BSC itself according to “MS position registration”. Thereafter, the LOS always routes the ATM cell having the assigned MS number to the BSC to which the MS belongs. Even if the MS moves from the area covered by the BSC, routing setting information (control information) is transmitted from the BSC to each LOS in order to route the VCI/VPI of the MS registered to the LOS to the BSC, so that the BSC can receive voice information.

A call origination procedure on an MS side in a mobile wireless communications system is described below.

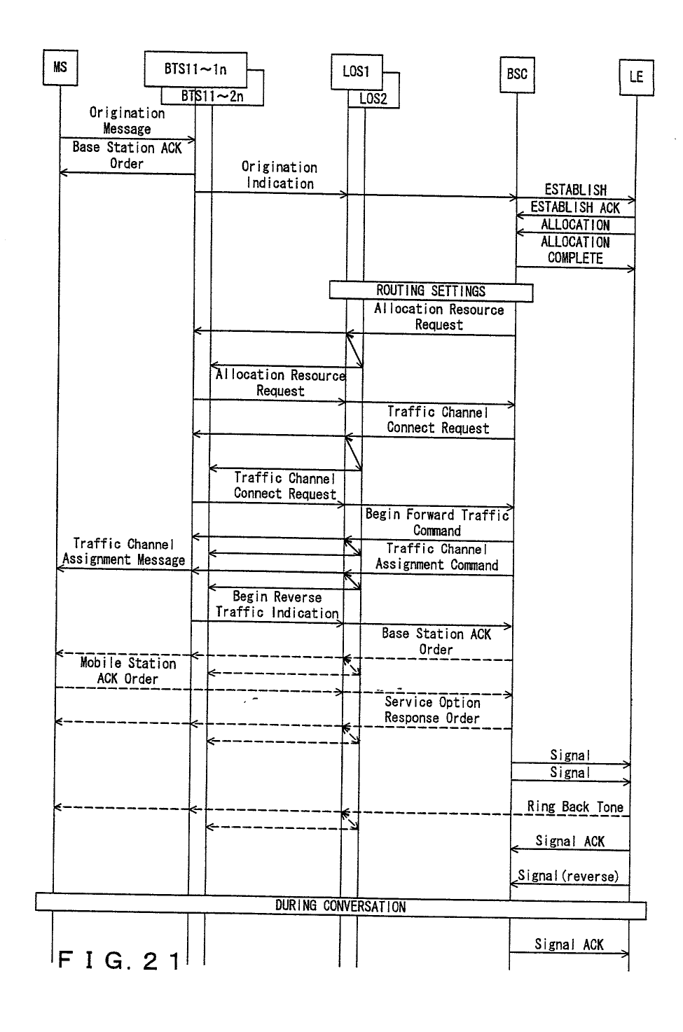

FIG. 21 shows the sequence for explaining the call origination procedure of an MS.

The fundamental call origination sequence is nearly equal to that in a WLL system. However, since the position of an SU (Subscriber Unit) subordinate to a BTS is fixed in the WLL system, a BSC cannot have the positional information of the SU if it moves like an MS. Accordingly, when the MS stays within the cell of the BTS subordinate to the BSC itself, to which the MS originally belongs, a message of the call origination sequence can be transmitted/received. However, a message cannot be transmitted/received when the MS stays within the cell of a different BTS that belongs to the BSC itself, or within the cell of a BTS subordinate to a different BSC, so that a conversation cannot be made.

Accordingly, a message in the direction from the LE to the MS in the call origination procedure on the MS side can be transmitted/received by adding a route from a local BSC, a subordinate LOS, a different BTS, to the MS, or a route from a local BSC, a subordinate LOS, an LOS subordinate to a different BSC, a BTS, to the MS, not only on a route from a local BSC, a subordinate LOS, a BTS to which the MS originally belongs, to the MS, even when a call is originated by the MS subordinate to the local BSC from within the cell of a different BTS or the cell of a BTS subordinate to a different BSC. Consequently, a conversation can be made. This route addition can be implemented by adding the routing setting procedure to a different LOS in an ATM SW unit of an LOS.

Described below is the case where a message can be transmitted/received with the routing setting from an LE, a BSC, all of subordinate BTSs, to an MS, if the MS stays within the cell of any of the BTSs subordinate to the BSC, which does not have the positional information of the MS, so that the call origination sequence can be established. Furthermore, by making routing settings not only for a local BSC but also for a BTS subordinate to a different BSC in a similar manner, a message can be transmitted/received even if an MS stays within the cell of the BTS subordinate to the different BSC, whereby the call origination sequence can be established.

FIG. 21 assumes that an MS is subordinate to a BTS11.

An origination message is transmitted from the MS to the BTS11, and an origination indication is transmitted from the BTS11 to an LE via an LOS1 and a BSC. While allocation messages are exchanged between the BSC and the LE, the BSC makes routing settings for the BSC itself and the LOS1, that is, the BSC sets a route from the LOS1 to the BTS11 through BTS1n, and a route to BTS21 through BTS2n via an LOS2.

In the subsequent sequence, the message transmission in the direction from the LE to the MS is made from the BSC to all of subordinate BTSs via the LOS1 and the LOS2.

Namely, when an origination message is transmitted from the MS to the BTS11, the BTS11 returns a response message called a base station ACK order to the MS. At the same time, the BTS11 transmits an origination indication to the LE via the LOS1 and the BSC, and notifies the LE that the MS is to be registered to the LE. The BSC establishes a line connection with the LE, and receives its response ACK. Then, the LE allocates a line to the MS by transmitting an allocation message to the BSC. The BSC returns a message (allocation complete) in response to this message. Additionally, routing settings are made between the BSC and the LOS1 and the LOS2. Then, the BSC transmits an allocation source request to actually connect the MS to the LOS1, the LOS2, and the BTSs 11 through 1n and 21 through 2n. Upon completion of the resource allocation, each of the BTSs returns an allocation resource response to the BSC via the LOS1 and the LOS2.

Next, the BSC transmits a traffic channel connect request to the BTSs 11 through 1n and 21 through 2nrespectively via the LOS1 and the LOS2. When a traffic channel connection is enabled, each of the BTSs returns a traffic channel response to the BSC. Then, the BSC returns a begin forward traffic command that notifies the start of upstream traffic to the BTSs 11 through 1n and 21 through 2n via the LOS1 and the LOS2. Furthermore, the BSC transmits a traffic channel assignment command to the BTSs 11 through 1n and 21 through 2n via the LOS1 and the LOS2. Especially, the BTS11 transmits a traffic channel assignment message to the MS. Each of the BTSs 11 transmits a begin reverse traffic indication, which is a request to start a downstream communication, to the BSC via the LOS 1. Then, the BSC transmits a base station ACK order to the MS. The MS returns a mobile station ACK order, which is a response signal, to the BSC. Next, the BSC transmits a service option response order to verify a service option to each of the BTSs and the MS. The BSC then transmits a signal for connecting a line to the LE. When the line connection is enabled, a ring back tone is transmitted to the MS. This ring back tone is transmitted also to each of the BTSs. When the LE transmits a signal ACK in response to the signal to the BSC, and a signal (reverse) instructing to notify the termination of a conversation is transmitted to the BSC, the conversation becomes possible. When the conversation is terminated, the BSC transmits a signal ACK to the LE.

The call termination procedure on the MS side in the mobile wireless communications system is described below.

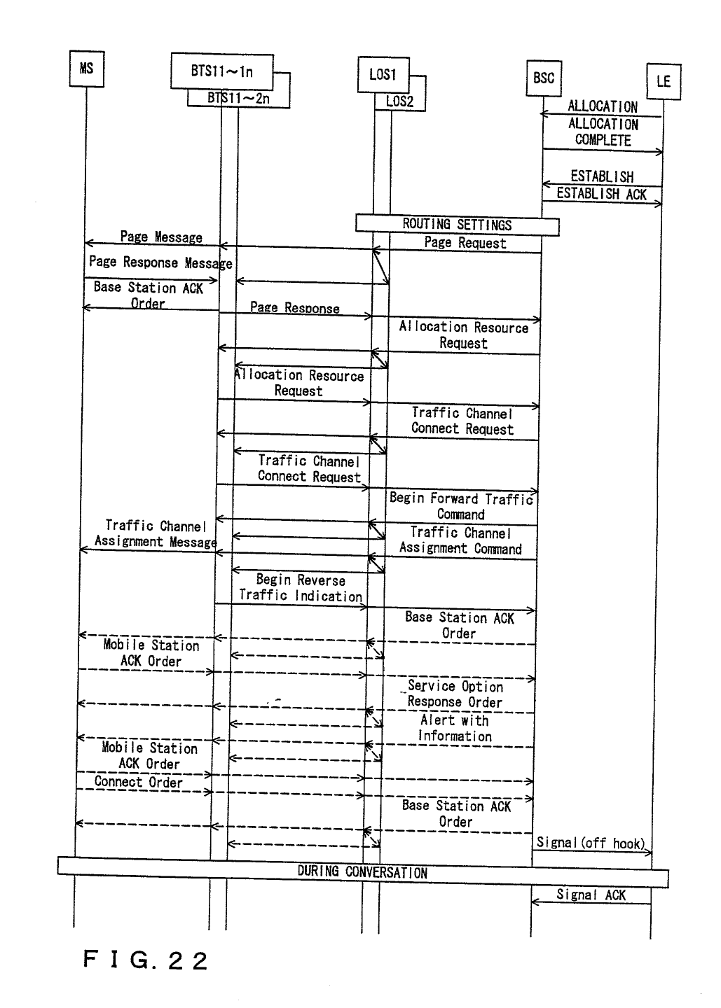

FIG. 22 shows the sequence representing the call termination procedure of an MS.

Although the fundamental sequence is nearly equal to that in the WLL system, the BSC does not have the positional information of an MS. Therefore, likewise the call origination, a message of the call termination sequence can be transmitted/received to/from the MS similar to the call origination procedure by adding a route from a local BSC, a subordinate LOS, a BTS other than a BTS to which the MS originally belongs, to the MS, or a route from a local BSC, a subordinate LOS, an LOS subordinate to a different LOS, a BTS, to the MS. This route addition can be implemented by adding the routing setting procedure for a different LOS in an ATM SW unit within an LOS.

FIG. 22 assumes that an MS is subordinate to the BTS11.

While allocation messages are exchanged between an LE and a BSC, the BSC makes routing settings for the BSC itself and an LOS1, and sets a route from the LOS1 to the BTSs 11 through in and a route to the BTSs 21 through 2n via the LOS2.

Next, the BSC transmits a page request to all of subordinate BTSs via the LOS1 and an LOS2, and the BTS transmits a page message to its subordinate MS.

In the subsequent sequence, a message transmission in the direction from the LE to the MS is made from the BSC to all of the subordinate BTSs via the LOS1 and the LOS2.

Namely, when the LE transmits an allocation message to the BSC and allocation is completed, its response, allocation complete, is returned to the LE. Then, an establish message is transmitted from the LE, and an establish ACK is returned to the LE. During that time, routing settings are made between the BSC and the LOS1 and the LOS2.

Thereafter, a page request is transmitted from the BSC to each of the BTSs and the MS via the LOS1 and the LOS2 so as to establish synchronization. A page response message is transmitted from the MS to the BTS11, and a base station ACK order is transmitted to the MS. Furthermore, a page response is transmitted from the BTS11 to the BSC via the LOS1.

Then, an allocation response request is transmitted to each of the BTSs, and an allocation resource response is returned to the BSC. Next, a traffic channel connect request is transmitted to each of the BTSs via the LOS1 and the LOS2, and a traffic channel connect response in reply to the above described request is returned to the BSC. Then, a begin forward traffic command is transmitted to each of the BTSs. Furthermore, a traffic channel assignment command is transmitted to each of the BTSs, and a traffic channel assignment message is transmitted to the MS.

From the BTS11, a begin reverse traffic indication is transmitted to the BSC. A response to this indication is returned to each of the BTSs and the MS as a base station ACK order. A mobile station ACK order is returned from the MS to the BSC in reply to the base station ACK order. Also an alert with information is transmitted to each of the BTSs and the MS. In reply to the alert with information, a mobile station ACK order is transmitted from the MS to the BSC, and a connect order message, which is a connection request, is transmitted to the BSC. When the BSC returns a base station ACK order in reply to this message, a signal is transmitted to the LE. As a result, a conversation becomes possible. Upon termination of the conversation, a signal ACK is transmitted from the LE to the BSC.

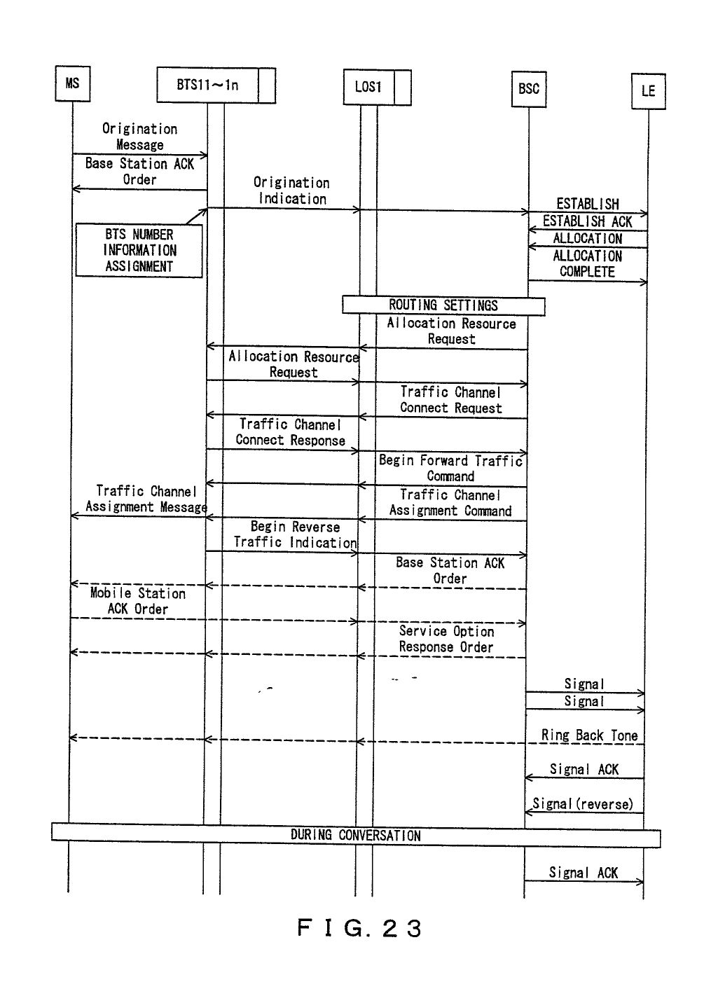

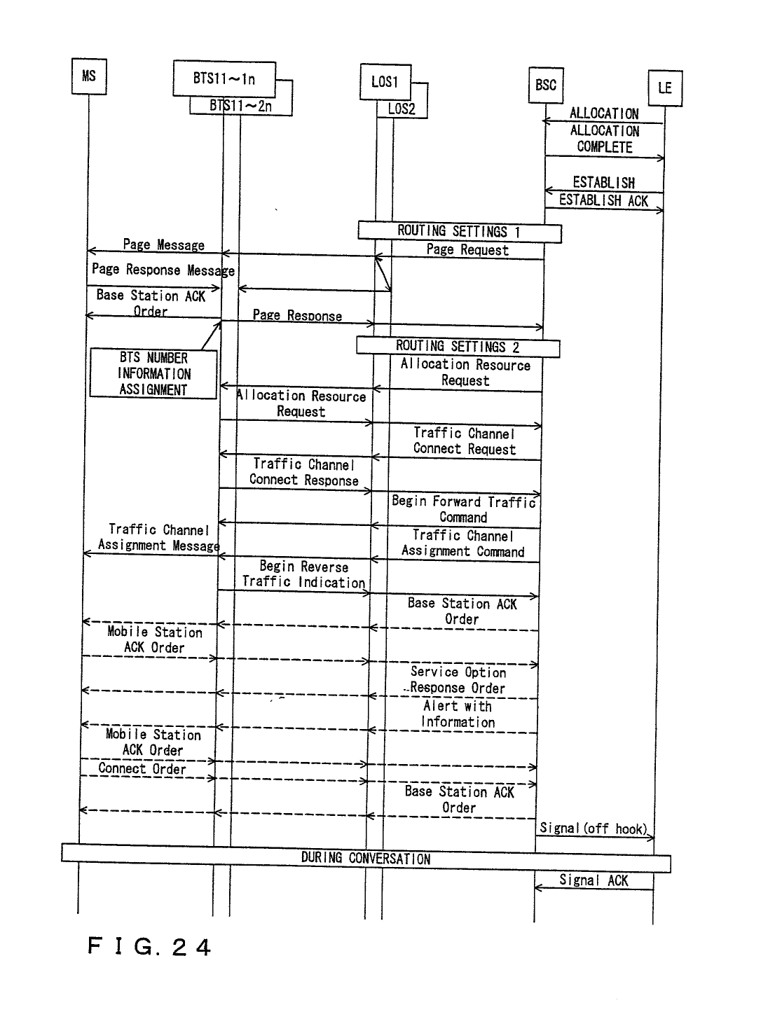

FIGS. 23 and 24 show the sequence representing another preferred embodiment of the call origination/termination process on the MS side.

In the above described sequence, the BSC does not have the positional information of an MS. Therefore, even if routing settings are made by the packet SW unit of the LOS, a message is transmitted also to a BTS to which no corresponding MS belongs when the message is transmitted in the direction from the LE to the MS. As a result, transmission efficiency is deteriorated. Accordingly, a BTS assigns the number information of the BTS connected to the MS to the message in the direction from the MS to the LE, and transmits the message to the BSC.

The BSC identifies and manages the positional information of the MS, and makes routing settings for the packet SW unit of the subordinate LOS. Because this routing setting is made only for a BTS to which a corresponding MS belongs, a message transmission in the direction from the LE to the MS can be made with high efficiency.

FIG. 23 assumes that an MS is subordinate to the BTS11 in the call origination sequence.

First of all, an origination message is transmitted from the MS to the BTS11. The BTS11 that receives this message assigns the number of the BTS itself, and transmits the message to the LOS1 (origination indication).

While allocation messages are exchanged between the LE and the BSC, the BSC makes routing settings for the BSC itself and the LOS1. However, since the BSC identifies the MS as staying within the cell of the BTS11, it sets only the route from the LOS1 to the BTS11.

In the subsequent sequence, a message transmission in the direction from the LE to the MS is made on the route from the LE, the BSC, the LOS1, the BTS11, to the MS.

Since the rest of the sequence is the same as that shown in FIG. 21, its explanation is omitted here.

FIG. 24 assumes that an MS is subordinate to the BTS11 in the call termination sequence.

While allocation messages are exchanged between the LE and the BSC, the BSC makes routing settings for the BSC itself and the LOS1, and sets a route from the LOS1 to the BTSs 11 through 1n, and a route to the BTSs 21 through 2n via the LOS2. Because a message transmission from the MS has not been made yet, route settings for all of the BTSs are performed.

Next, a page request is transmitted from the BSC to all of the subordinate BTSs via the LOS1 and the LOS2. Then, each of the BTSs 11 transmits a page message to its subordinate MS. In reply to this message, the MS returns a page response to the BTS11. The BTS11 then assigns the number of the BTS itself, and transmits the page response to the LOS1.

Next, the BSC makes routing settings for the BSC itself and the LOS1. Because the BSC identifies the MS as staying within the cell of the BTS 11, it sets only the route from the LOS1 to the BTS11.

In the subsequent sequence, a message transmission in the direction from the LE to the MS is made only on the route from the LE, the BSC, the LOS1, the BTS11, and to the MS.

Because the rest of the sequence is the same as that shown in FIG. 21, its explanation is omitted here.

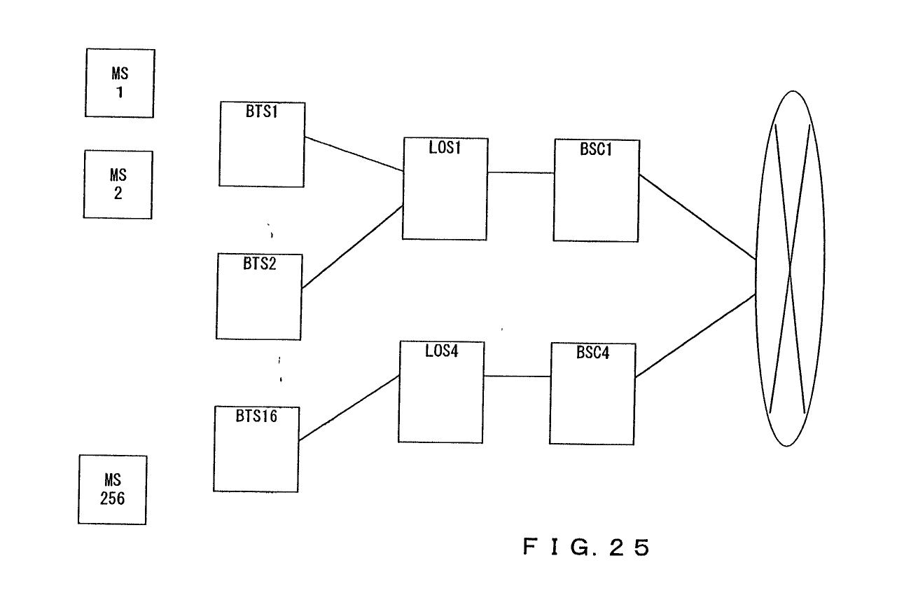

FIG. 25 explains the method for assigning a BTS number.

When a BTS number is assigned from an MS to the BTS, specifically, the following method is used.

For example, in the system shown in FIG. 25 (16 BTSs and 4 BSCs), the VCI/VPI value of a voice information (TYPE 0) cell of an MS is defined as follows.

VCI 8 bits 000A BBBB

VPI 16 bits=CCCC CCCC CCCC CCCC

A=TYPE identification (TYPE 5 or TYPE 0)

B BTS number (0 to 15)

C=MS number (0 to 256)

Upon receipt of voice information transmitted from an MS1 belonging to a BSC 1 from a BTS1, an LOS1 routes the voice information to a BSC #1 by examining the number (=0000 0000) of the MS1. The BSC1 transmits the voice information to a network (PSTN) according to the number of the MS within the received cell. The BSC1 stores the BTS number (=0000) of the cell received at this time, assigns a VPI=0000 0000 as a destination to downstream voice information toward the MS1, which is received from the PSTN, assigns neighboring BTS numbers (such as 0001 and 0002), and transmits the information. Namely, 3 cells having the VCI (=0×0, 0×1, and 0×2) and the VPI (=0×00) are transmitted. If the number of the BTS subordinate to the LOS1 itself exists in the VCI (BTS number) of the downstream voice cells, the LOS1 transmits the cells to the corresponding BTS. If the number of the BTS subordinate to the LOS1 itself does not exist, the LOS1 transfers the cells to a different LOS.

Since a plurality of BTSs share the same frequency carrier with a CDMA method, a plurality of adjacent BTSs can receive a radio wave transmitted from one MS. Furthermore, carriers transmitted from a plurality of BTSs can be simultaneously received (RAKE-received) by an MS.

First of all, the procedure for a hand-off between BTSs in a general CDMA cellular system is described.

An MS comprises the capability for grasping the radio wave status in a current area by observing the strength of a pilot signal from a BTS, etc. The MS can simultaneously detect the strengths of radio waves in the current area and a plurality of different areas. If the strength of a radio wave from an area (BTS) other than the current area, which is detected with this capability, exceeds a preset threshold, the MS issues a hand-off request to the current area BTS.

The BTS that receives the hand-off request notifies its superordinate BSC of the reception of the hand-off request.

The BSC that receives the notification selects a transfer destination BTS, and issues a hand-off instruction to the selected BTS and the current area BTS (source BTS). At the same time, the BSC secures a hand-off resource (a call acceptance resource) of the destination BTS and that within the BSC itself, and establishes a detour communications path between the BSC and the BTS.

The destination BTS that receives the hand-off instruction receives the carrier transmitted from the target MS by using the allocated hand-off resource, and transmits the carrier to the target MS.

In this way, the currently used path and the hand-off path are established in parallel between the MS, the plurality of BTSs, and the superordinate BSC.

A hand-off in the direction from the MS to the BSC (upstream direction) is as follows.

A plurality of adjacent BTSs respectively transmit the quality information of a signal received from an MS to the BSC. The BSC that receives the quality information manages and monitors these pieces of information. By selecting a path of high quality, a soft hand-off (a hand-off with no instantaneous chopping) can be implemented. This is because a signal is never chopped instantaneously even when an MS moves between the cells of a plurality of adjacent BTSs.

A hand-off in the direction from the BSC to the MS (downstream direction) is as follows.

A plurality of BSCs simultaneously transmit the same information to a plurality of associated (adjacent) BTSs for a target MS, and the plurality of adjacent BTSs simultaneously transmit the information with the same frequency carrier. The target MS simultaneously receives (RAKE-receives) these carriers, and selects and uses an optimum path similar to that in the upstream direction, so that a soft hand-off (a hand-off with no instantaneous chopping) is implemented.

If the strength of a pilot signal from a destination BTS finally exceeds a preset threshold, the MS transmits a successful hand-off notification to the destination BTS.

The BTS that receives this notification transfers it to the BSC, which then issues a resource release instruction to the source BTS.

The source BTS that receives this instruction releases the communications path (resource release/carrier stoppage).

In this preferred embodiment, the above described soft hand-off control messages are exchanged via the LOS, thereby implementing the soft hand-off.

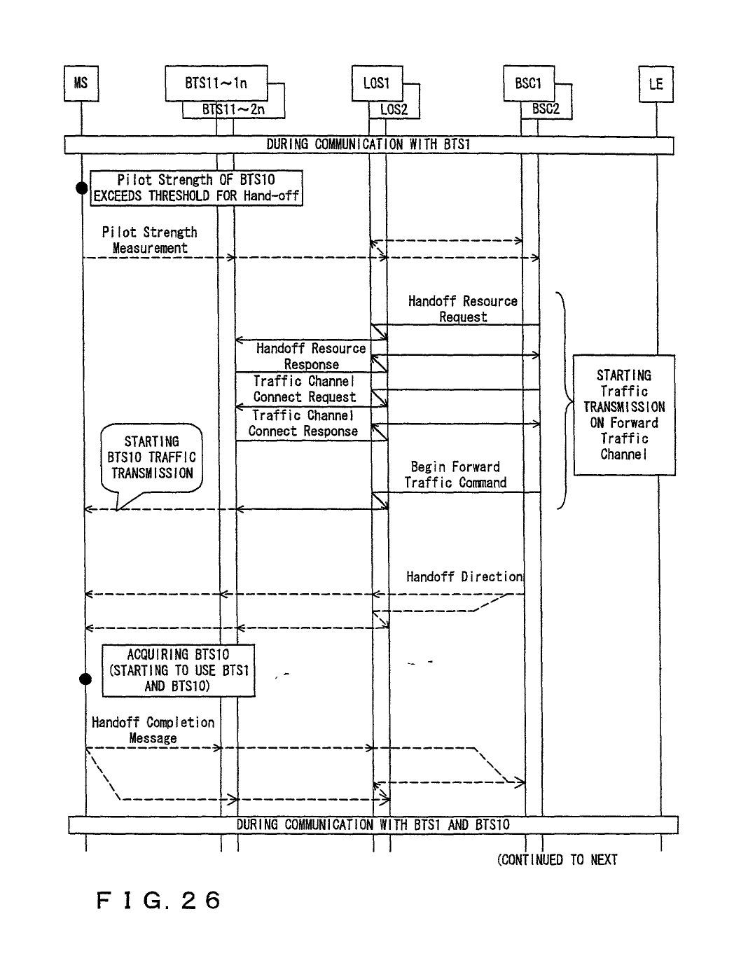

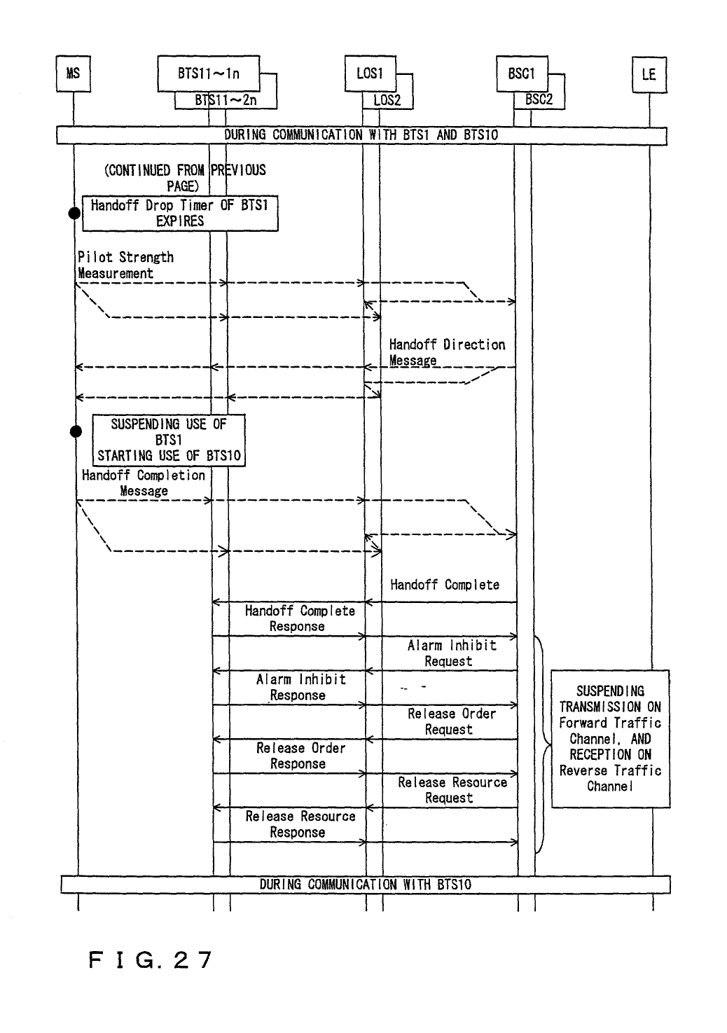

FIGS. 26 and 27 show the sequence representing the process performed when a hand-off is performed.

This process is explained by taking as an example the case (soft hand-off between BSCs) where an MS moves from the cell of a BTS subordinate to a local BSC to that of a BTS subordinate to a different BSC.

FIGS. 26 and 27 show the procedure of the soft hand-off between BSCs when an MS staying within the cell of a BTS1 subordinate to a BSC1 moves to the cell of an adjacent BTS10 (subordinate to a BSC2).

First of all, the MS is making a conversation within the cell of the BTS1. When the MS begins to move to the direction of the BTS10, a pilot signal of the BTS10 starts to be caught in the vicinity of the boundary of the cell. If the strength of this pilot signal exceeds a predetermined numerical value, this is notified from the MS to the BTS10. The BTS10 then notifies the BSC1 that the MS is approaching the cell of the BTS10 itself with a pilot strength measurement message. Since the MS originally belongs to the BTS1 subordinate to the BSC1 in this case, the notification target is the BSC1.

The BSC1 that receives this message determines that the BTS10 is the transfer destination of the hand-off, attaches an address indicating the BTS10 to the header, and transmits a hand-off resource request (hand-off resource allocation request) to the LOS1. The LOS1 transmits the message to the LOS2 side, which is an output line toward the BTS10, according to the header of the above described message. Also the LOS2 that receives the message relays this message to the output line toward the BTS10 according to the header of the message in a similar manner. Finally, the hand-off resource request message reaches the BTS10.

The BTS10 that receives the hand-off resource request message secures its internal circuit resources (spread code/connection entrance line channel, etc.) for the hand-off by one line. When entering a state in which a traffic path can be established whenever receiving an instruction from the BSC, the BTS10 transmits a hand-off resource response (hand-off resource allocation response) message, to which the header indicating the BSC1 is attached, to the LOS2.

The hand-off resource response message is relayed to the BSC1 via the LOS2 and the LOS1 with a procedure similar to that described above, and the message finally reaches the BSC1.

Also the following message relay is assumed to be performed in a similar manner as in the above described message relay.

Thereafter, the BSC1 secures its internal circuit resources (entrance line channel for the BTS/voice codec) for the hand-off by one line. When the BSC1 is ready, it transmits a traffic channel connect request message to the BTS10 (by attaching a header indicating the BTS10). After the BTS10 that receives the traffic channel connect request message starts up the hand-off resources, it returns a traffic channel connect response to the BSC1 (by attaching a header indicating the BSC1) The BSC1 that receives the traffic channel connect request message transmits a begin forward traffic command (a BTS-to-MS traffic line transmission instruction) and a downstream traffic message transmitted to the BTS10 (by attaching the header indicating the BTS10). The BTS10 that receives the begin forward traffic command message transmits a carrier on which the traffic message is spread to an aerial side (on the MS side via an aerial wire side) by using the spread code secured as the hand-off resource.

At this time, a call process message between the BSC and the MS is multiplexed within the traffic message in addition to voice information being user data, and a hand-off direction (hand-off instruction) is inserted in the traffic message. The hand-off direction message is transmitted from both of the current area BTS (BTS1) and the destination BTS (BTS10) to the target MS. When entering a state of being able to receive the traffic message from the BTS10 being the destination BTS, the MS that receives the hand-off direction message makes a state transition to the RAKE reception, inserts a hand-off completion message in an upstream traffic message similar to the downstream traffic message, and notifies the BSC1 of the transition to the hand-off state.

The MS comprises the capability for receiving the traffic information from each of the BTSs, and estimating its error rate. The MS multiplexes this error rate information, the above described hand-off completion message, and upstream voice information, and transmits an upstream traffic carrier.

The upstream traffic carrier is received by both of the BTS1 being the current area BTS (source BTS) and the BTS10 being the hand-off destination. Both of these BTSs transmit the traffic carrier to the BSC1.

Upon receipt of the hand-off completion message, the BCS1 examines the error rate information within the upstream traffic messages transferred from the BTS1 and the BTS10, and selects information of higher quality (lower error rate).

At this time, the hand-off state of two ways such as a way from the target MS, the BTS1, the LOS2, to the BSC1, and a way from the MS, the BTS2, the LOS2, the LOS1, to the BSC1 is implemented.

Next, in FIG. 27, the MS further moves to the direction of the BTS10, and attempts to get out of the cell of the BTS1. Therefore, the strength of the pilot signal of the BTS1 becomes low in the MS, and the conversation between the MS and the BTS1 is getting disconnected. At this time, a hand-off drop timer of the BTS1 works, and the MS notifies the BSC1 with a pilot strength measurement message that the conversation with the BTS1 is likely to be disconnected.

The BSC1 that receives this message transmits commands such as an alarm inhibit, a release order, and a release resource to the BTS1 in order to release the path between the MS and the BTS1, so that the conversation between the MS and the BTS1 is terminated. As a result, only the path from the BSC1, the LOS1, the LOS2, the BTS10, to the MS is established. Here, the alarm inhibit message is intended not to issue an alarm temporarily, so that an erroneous alarm signal is prevented from occurring due to noise, etc. at the time of hand-off switching.

In a current mobile communications system, it is general to put voice packet information to be transmitted, etc. into an ATM cell. Bandwidth of a voice channel between an MS and the system is suppressed to several kbps or so, from the viewpoint of an effective use of wireless resources.

If one voice channel is transmitted by being ridden on one ATM cell, the payload of the cell becomes partially empty, which is inefficient if the communication capacity of a transmission line is small. Therefore, as is always the case, a protocol dedicated to mobile communications, which is called a “composite cell” and configured as one ATM cell by bundling a plurality of voice channels, is used.

However, when the composite cell is used, both of transmitting and receiving ends of an ATM cell transmission line must multiplex and demultiplex voice channels in a predetermined format. Accordingly, both of the transmitting and the receiving ends must comprise dedicated hardware and software. Especially, when a system of a large capacity is built, the device and the system tend to be large-scale and expensive.

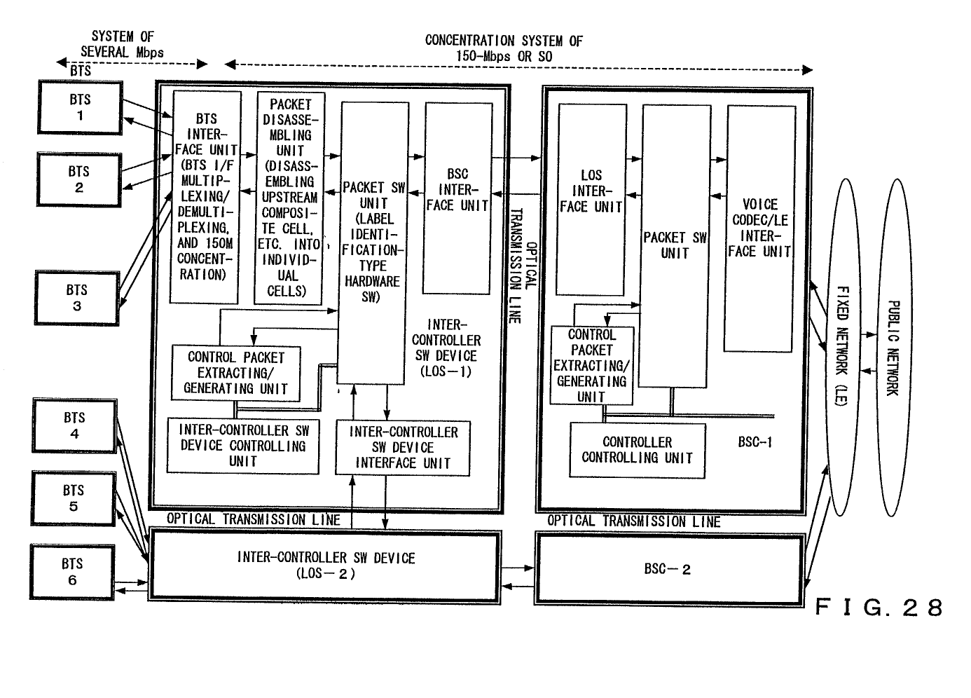

FIG. 28 exemplifies the configurations of LOSs and other constituent elements when the composite cell is used.

In a mobile wireless communications system that enables a mobile communication of a wireless MS connected to an arbitrary wireless BTS, a high-speed optical interface (such as 150-MHz SDH, etc.) is concentrated to one line to make a connection between LOSs comprising a packet routing capability, and between an LOS and a BSC. Here, packet data may be transmitted by being put into an ATM cell that can be switched at high speed.

In this preferred embodiment, the connection between an LOS and a BSC is replaced by a high-speed line having a capacity equal to or larger than the entire capacity of a connecting line between a BTS and an LOS, a 150-MHz SDH-like optical line in this case, and the line is concentrated within the LOS, thereby eliminating the need for arranging a speed conversion capability and a connecting line distribution capability in both of the LOS and the BSC.

Next, a signal process flow is explained with reference to FIG. 28.

In this figure, BSCs (a BSC-1 and a BSC-2) of two systems are connected to the same fixed network LE, and a connection is made between each BTS and an LOS by using a low-speed entrance line on the order of several Mbps. In the meantime, connections are made between an LOS and a BSC, and between LOSs by using an optical line (such as 150-MHz SDH, etc.) of one system, which has much broader bandwidth than the sum total of the communication bandwidths of entrance lines.

First of all, a signal flow on a reverse link (in the direction from a BTS, an LOS, a BSC, to an LE) is explained.

When voice and call control signals that are wirelessly transmitted from an MS are received, for example, by a BTS-1, these signals are encapsulated into one packet or ATM cell within the BTS-1, and transmitted to an upstream LOS-1, although this is not shown in FIG. 28.

In the LOS-1, a BTS interface unit receives this packet or ATM cell. The BTS interface unit speed-converts this packet or ATM cell along with packets or ATM cells from the other BTS-2 and BTS-3 to 150 MHz, multiplexes these cells, and transmits the multiplexed cell to a packet disassembling unit at the next stage. Thereafter, the received signal is concentrated to 150-Mbps transfer speed, and processed.

The packet disassembling unit disassembles the composite packet (encapsulated into the same packet or ATM cell) into individual packets. A transmission destination label is attached to the disassembled individual packets by an inter-controller SW device controlling unit, and the packets are transmitted to a packet SW unit at the succeeding stage.

Upon receipt of the packets or ATM cells to which the destination label is attached, the packet SW unit hardware-switches and transmits the packets or ATM cells to an output line (the local upstream BSC side (the BSC-1 in this case) or a different upstream BSC side (the BSC-2 in this case)), which is specified by the destination label).

Here, the explanation is continued by assuming that the specified output line is the local BSC side.

If the packets or ATM cells are transmitted to the local BSC, they are transmitted to a BSC interface unit within the local LOS.

The BSC interface unit converts the packets or ATM cells received from the packet SW unit into an optical signal, and transmits the optical signal to an optical transmission line between BSCs.

The local BSC receives the optical signal from its subordinate LOS in an LOS interface unit, restores the optical signal into an electric signal in the LOS interface unit, extracts the original packets or ATM cells, and transmits the extracted packets or ATM cells to a packet SW unit at the next stage.

The packet SW unit hardware-switches the received packets or ATM cells with a procedure similar to that of the packet SW unit within the LOS according to the control of a controller controlling unit within the BSC, and transmits the packets or ATM cells to the corresponding output line (the corresponding port of a voice codec/LE interface unit).

The voice codec/LE interface unit converts the compressed and encoded voice signal within the received packets or ATM cells into the format of a signal used by a normal public line, such as a 64-kbps PCM signal, etc., and transmits the signal to the LE side.

Next, a signal process flow on a forward link (in the direction from the LE, the BSC, the LOS, to the BTS) is explained.

For user information such as a voice signal, etc., transmitted from the public network side, the BSC to which a destination SU (wireless fixed station) should originally belong is selected within the LE. The user information is then transmitted to the BSC to which the station belongs. However, an actual destination is an MS (wireless mobile station), and there is a possibility that the station moves from the area of the BSC to which the station belongs. Here, explanation is provided by assuming that the destination MS exists within the wireless area of a BTS-5.

Upon receipt of the user information such as the above described voice signal, etc., the BSC-1 converts the information into a packet or ATM cell within the voice codec/LE interface unit, and makes the voice codec/LE interface unit transmit the packet or ATM cell to the packet SW unit. Similar to the reverse link side, the voice signal is also compressed and encoded in the voice codec/LE interface unit.

The packet SW unit identifies the attribute of the packet or ATM cell received from the voice codec/LE interface unit. If the attribute is user information, the packet SW unit switches the packet or ATM cell to the LOS interface unit unchanged. If the attribute is information of a call process, monitor control, etc., the packet SW unit switches the packet or ATM cell to a control packet extracting/generating unit. Upon receipt of the above described information of call process, monitor control, etc., the control packet extracting/generating unit restores the payload of the packet or ATM cell, and transmits it to the controller controlling unit, so that the control information, etc. from the LE is received.

The user information packet or ATM cell such as the voice signal, etc., which is received by the LOS interface unit, is converted into an optical transmission signal within this unit, and relayed to the LOS-1.

In the LOS-1, a BSC interface unit restores the optical signal into an electric signal, and transmits the electric signal to the packet SW unit. At this time, a multicast label (for switching to all of output lines other than input lines and the control packet extracting/generating unit side) is attached as an output line label.

The packet SW unit directs the received packet or ATM cell to all of the output lines (the packet disassembling unit side and the LOS interface unit side in this case) according to the multicast label.

The packet or ATM cell directed to the packet disassembling unit is transmitted to a BTS interface unit unchanged. The BTs interface unit converts the packet or ATM cell into the speed of each entrance line, and simultaneously transmits the packet or ATM cell to the BTS-1 through the BTS-3.

The packet or ATM cell directed to the inter-controller SW device interface unit is converted into an optical transmission line signal in the LOS interface unit, and transmitted to the LOS-2 side.

If the multicast label is attached to the received packet or ATM cell, the packet SW unit identifies the packet or ATM cell as a forward link side user signal, and switches the packet or ATM cell to all of the output lines (Only the packet disassembling unit side within the LOS-2 in this case. The packet or ATM cell is output also to the LOS-3 side if the LOS-3 system is connected.) other than the input line side, the control packet extracting/generating unit side, and the reverse link side (that is, the BSC-2 side).

The packet or ATM cell reaching the BTS interface unit within the LOS-2 is speed-converted into the speed of an entrance line to each of BTSs (a BTS-4 through a BTS-6) in a similar manner as in the LOS-1, and transmitted simultaneously.

In this way, the user information from the LE via the BSC-1 is transmitted to all of the BTSs subordinate to the LE in a broadcast-like manner.

The above description is based on the premise that the MS exists within the wireless area of the BTS-5. As a consequence, the user packet or ATM cell reaching the BTS-5 is wirelessly transmitted from the BTS-5, whereby the signal connection from the public network to the destination MS can be implemented.

A preferred embodiment in the case where an ATM cell is used as a transmission signal in a fixed wireless system, ITU-T/SONET (156 Mbps) is used as an optical transmission line, and ITU-T G703 (2M system E1 interface) is used between a BTS and an LOS, and between a BSC and an LE is described below.

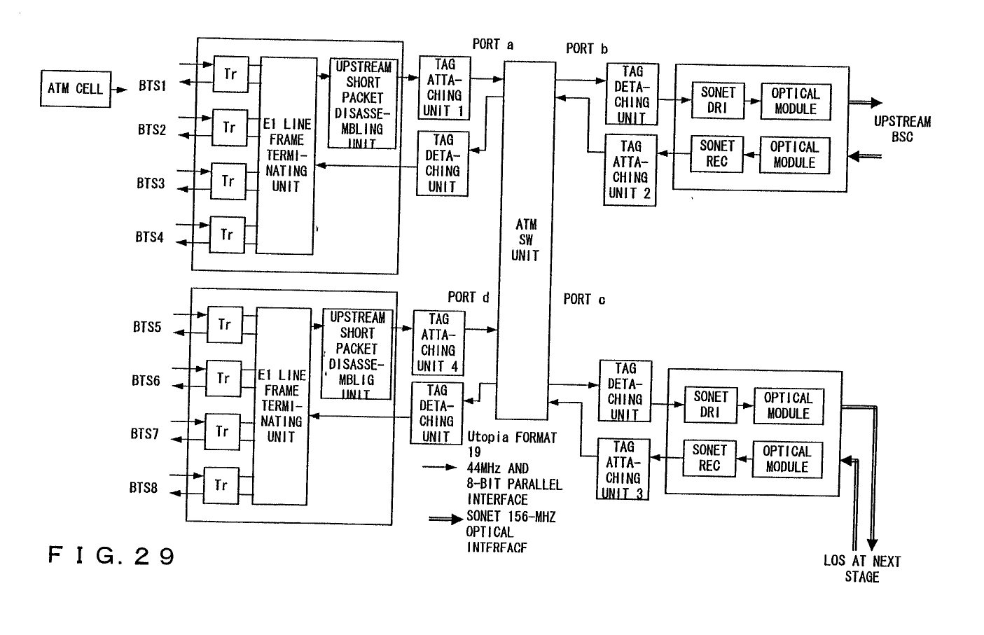

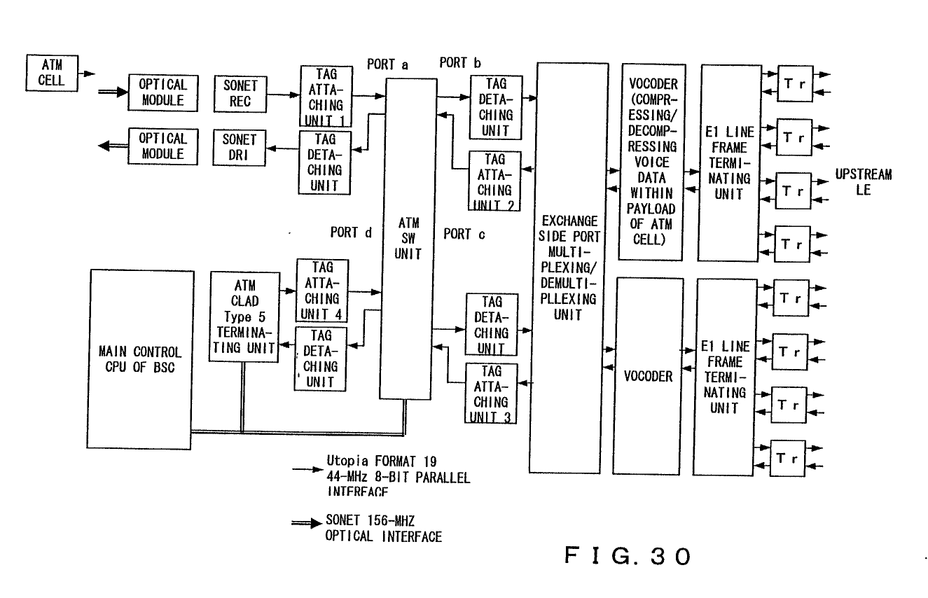

FIG. 29 exemplifies the hardware configuration of the LOS, whereas FIG. 30 exemplifies the hardware configuration of the BSC.

In the LOS shown in FIG. 29, an ATM cell the header of which is coded as follows on a BTS side is input from the BTS side to a transceiver Tr.

Identification code of a TYPE 2/5 cell For the TYPE 5 cell, a source BTS number is coded.

For the TYPE 2 cell, a source MS number (IMSI) is coded.

The ATM cell input to the transceiver TR in this way is terminated by an E1 line frame terminating unit. Then, an upstream short packet disassembling unit converts user data from a TYPE 2 format to a TYPE 0 format, and makes control data pass through unchanged as a TYPE 5 cell. Next, a tag attaching unit 1 attaches the port number for the belonging destination BSC to the TYPE 5 cell as a tag from the BTS number. Additionally, the tag attaching unit 1 attaches the number of the LOS connected to the belonging destination BSC to the TYPE 0 cell as a tag from the IMSI number. The cells are then input to an ATM SW unit, which makes switching based on the tags. The switched ATM cells are output from a port a or a port b, and their tags are detached. The cells are then transmitted as an optical signal from an optical module to the upstream BSC or the LOS at the next stage via a SONET driver.

Since the flow of the signal input from the upstream BSC or the LOS at the next stage is reverse to the above described flow, its fundamental explanation is omitted here. However, especially, if a signal is input from the LOS at the next stage, it is received by the optical module, and the SONET signal is terminated by a SONET receiver. Then, a tag attaching unit 3 attaches a tag specifying the port corresponding to a destination BTS number to the TYPE 5 cell, and a multicast tag specifying all of ports other than input line ports to the TYPE 0 cell. The cells are then input to the ATM SW unit, and transmitted.

In FIG. 30, an ATM cell as an optical signal input from a downstream LOS is coded as follows on a BTS side.

Identification code of a TYPE 2/5 cell For the TYPE 5 cell, a source BTS number is coded.

For the TYPE 2 cell, a source MS number (IMSI) is coded.

Then, such an ATM cell is received by an optical module, terminated by a SONET receiver, and input to a tag attaching unit 1. The tag attaching unit 1 attaches the port number for the belonging destination BSC as a tag to the TYPE 5 cell from the BTS number, and the number of an LOS connected to the belonging destination BSC to the TYPE 0 cell as a tag from the IMSI number. These cells are then switched by an ATM switch unit. Switching of the ATM SW unit is controlled by a main control CPU of the BSC. Additionally, since routing control information is carried by the TYPE 5 cell, this cell is terminated by an ATM CLAD TYPE 5 terminating unit. The ATM cells output from the ATM SW unit are output to a port b or a port c. After the tags are detached, the cells are multiplexed by an exchange side port multiplexing/demultiplexing unit. Then, voice data within the payload of the ATM cells are compressed/decompressed by a vocoder, configured as an E1 frame, and transmitted from a transceiver Tr to an upstream LE.

The flow of a signal input from the upstream LE is reverse to the above described flow. However, a tag attaching unit 3 attaches a tag specifying the port corresponding to a destination BTS number to a TYPE 5 cell, and a multicast tag specifying all of ports other than input line ports to a TYPE 0 cell.

In a mobile wireless communications system that is based on an existing fixed wireless system and enables a communication with a wireless mobile station which is wirelessly connected to an arbitrary wireless BTS, connections are respectively made by using a high-speed optical transmission line interface between inter-controller SW devices (LOSs), and between an inter-controller SW device and a BSC, whereby transmission paths can be concentrated within an LOS.

As a result, a signal can be transmitted unchanged between an LOS and a BSC with a 150-MHz optical interface, which eliminates the need for arranging the hardware and software for implementing speed conversion, multiplexing/demultiplexing, interface conversion, etc., which must be performed both in an LOS and in a BSC in a redundant fashion.

Additionally, if a signal is transmitted as an ATM cell, it is necessary to put a plurality of channels into a composite cell, and to transmit the composite cell from the viewpoint of an effective use of the payload of an ATM cell. Since a transmission with an individual cell can be enabled with the concentration effect of the present invention, a BSC side may relay individual cells into which a composite cell is disassembled within an LOS as they are on a reverse link.

As a result, the following effects can be obtained.

An effect of reducing hardware/software of an LOS and a BSC is promised.

Useless processing in the entire system is reduced, leading to an increase in a communication efficiency.

By additionally arranging a simple packet router in an existing fixed wireless system, a wireless mobile system can be implemented without installing a large-scale HLR, BLR, etc.

However, the configuration where a new device (a packet router) is added to an existing device is forced to be redundant (speed conversion and interface conversion capabilities, multiplexing/demultiplexing unit, etc. in respective devices) if viewed from the entire system.

Accordingly, a capability of an inter-controller SW device, which is a packet router, is incorporated into a BSC being an existing device, whereby more efficient and cost-effective system can be built.

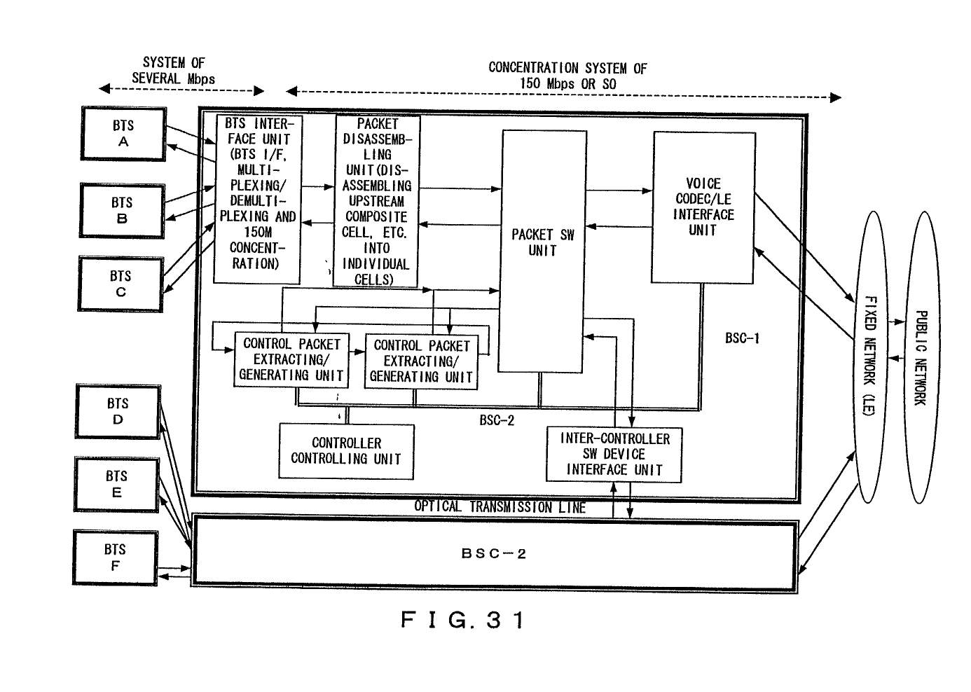

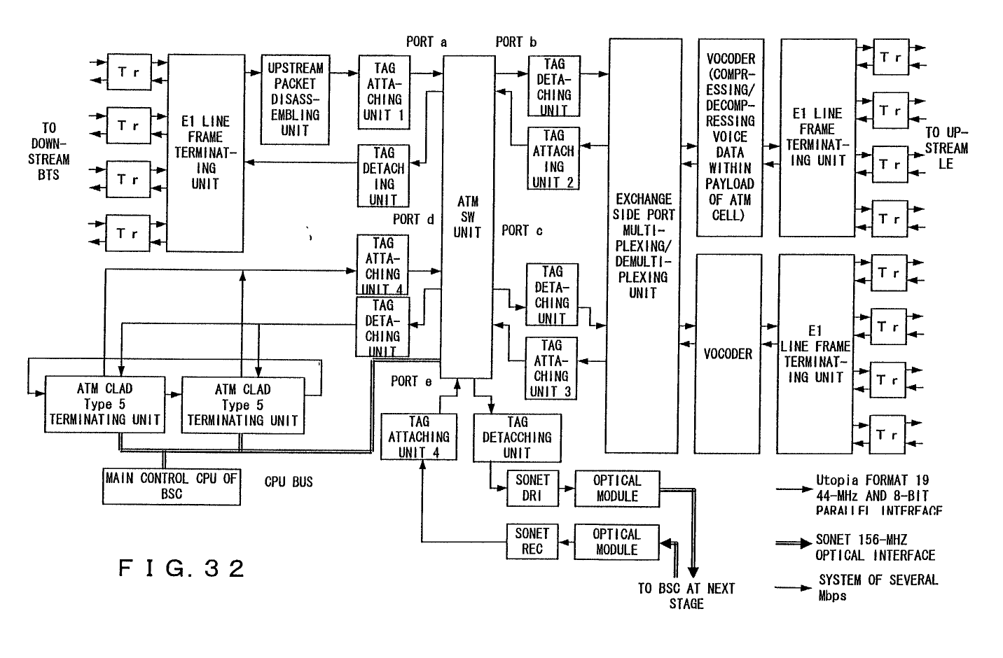

FIGS. 31 and 32 exemplify the configuration in the case where the capability of the inter-controller SW device is incorporated into a BSC.

Here, the configuration where the capability of the inter-controller SW device (LOS) is incorporated into a BSC is adopted. For this configuration, packet SW units, control packet extracting/generating units, and a controller main control unit and an inter-controller SW device controlling unit (in the BSC and the LOS) are combined and configured. The packet SW units are structured as a 4:4 SW configuration, and the control packet extracting/generating units are connected to the SW unit by a multiplexing process according to token control, etc.

The signal flow in each unit in FIG. 31 is similar to that shown in FIGS. 28 through 30. Namely, a packet or ATM cell input from each BTS is received by a BTS interface unit, terminated by a packet disassembling unit, and switched by a packet SW unit. Then, the packet or ATM cell is transmitted from a voice codec/LE interface unit to an upstream LE, or from an inter-controller SW device interface unit to a different BSC.

Additionally, a packet having control information is extracted by a control packet extracting/generating unit, and the control information is used by a controller controlling unit, so that the routing control of the packet SW unit is implemented. Furthermore, when control information is transmitted from the BSC, the controller controlling unit generates control information, and the control packet extracting/generating unit puts the control information into a packet, and transmits the packet via the packet SW unit.

FIG. 32 shows the configuration where BSCs are connected with a 156-MHz SONET optical transmission line interface. Although the connection between a BTS and a BSC is the same as a conventional connection, the inter-controller SW device capability according to the present invention is added within the BSC. An ATM cell received from the BTS passes through a BTS interface unit, and is disassembled by a packet assembling unit. The disassembled cells are switched by the packet SW unit as a signal proceeding to a different inter-controller SW device, a voice cell, and a signaling cell, which can be transmitted/received to/from respective paths. The BSC can transmit/receive a 150-MHz interface signal.

Because the other operations are similar to those of the corresponding units shown in FIGS. 28 through 30, their explanations are omitted here.

By adopting the above described configuration, a throughput delay can be prevented from occurring in the entire system, so that amore cost-effective system with a high communication efficiency, from which hardware and firmware redundant portions are eliminated, can be built.

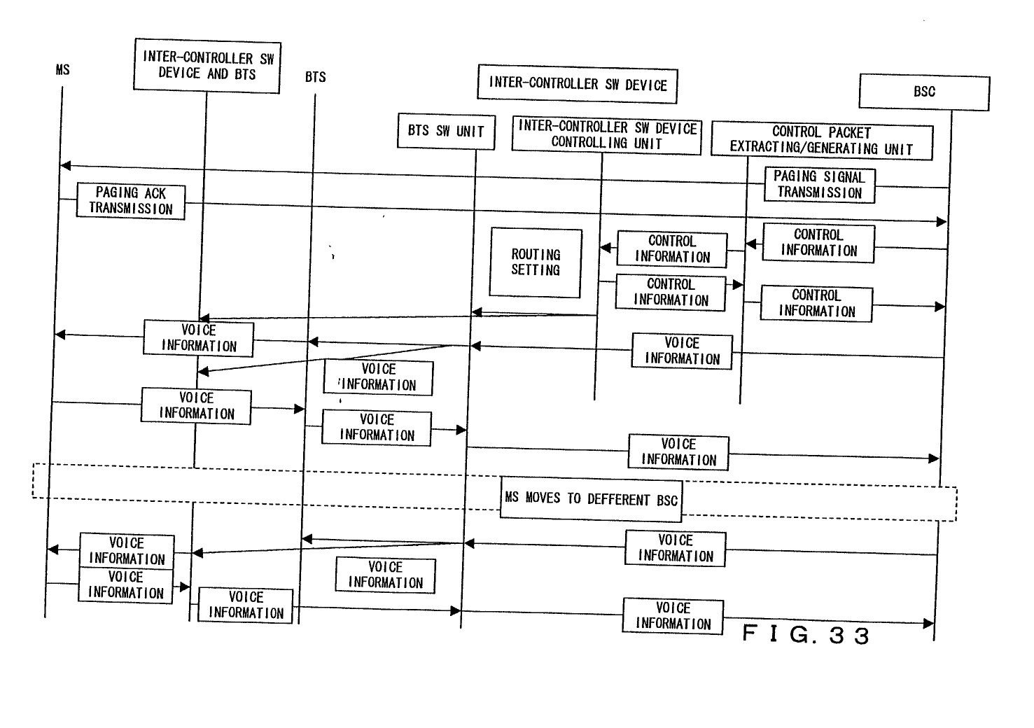

FIG. 33 shows the sequence at the time of call establishment in the preferred embodiments shown in FIGS. 31 and 32.

In this figure, the BSC transmits a synchronization (paging) signal to all of MSs via the inter-controller SW device having the hardware configuration shown in FIG. 31, and the BTS. The MSs that receive the synchronization (paging) signal transmit an ACK signal to the BTS. At this time, the BSC transmits control information including routing information to the inter-controller SW device. This control information is received by the inter-controller SW device controlling unit via the control packet extracting/generating unit. According to this routing information, the inter-controller SW device controlling unit makes routing settings for the packet SW unit. The inter-controller SW device controlling unit makes similar routing settings also for a different inter-controller SW device. As a result, a hardware-like path between the MS and the BSC is secured. Downstream (from the BSC to the MS) voice information from the BSC is transmitted to the BTS by the packet SW unit, and copied and transmitted to a different inter-controller SW device side, so that the voice information is transmitted to all of the MSs in a broadcast-like manner. Inversely, upstream (from the Ms to the BSC) voice information transmitted from an MS is assigned an MS number by the BTS, and received on the inter-controller SW device side. At this time, the voice information is received by the packet SW unit. If the assigned MS number matches the routing information set as described above, the voice information is transmitted to the BSC.

When the MS moves to the area of a different BSC, downstream (from the BSC to the MS) voice information is transmitted from the BSC to the BTS by the packet SW unit, and copied and transmitted to a different inter-controller SW device side, so that the voice information is transmitted to all of the MSs in a broadcast-like manner. Inversely, upstream (from the MS to the BSC) voice information transmitted from the MS is assigned an MS number by the BTS, and received on the inter-controller SW device side. At this time, the voice information is received by the packet SW unit. Because the assigned MS number mismatches the routing information set as described above (this inter-controller SW device cannot process the MS), the voice information is transmitted to the different inter-controller SW device side. The MS number assigned to the received voice information matches the routing information set as described above in the different inter-controller SW device (the device that becomes responsible for processing the MS in the initial negotiation). Therefore, the voice information is transmitted to the BSC.

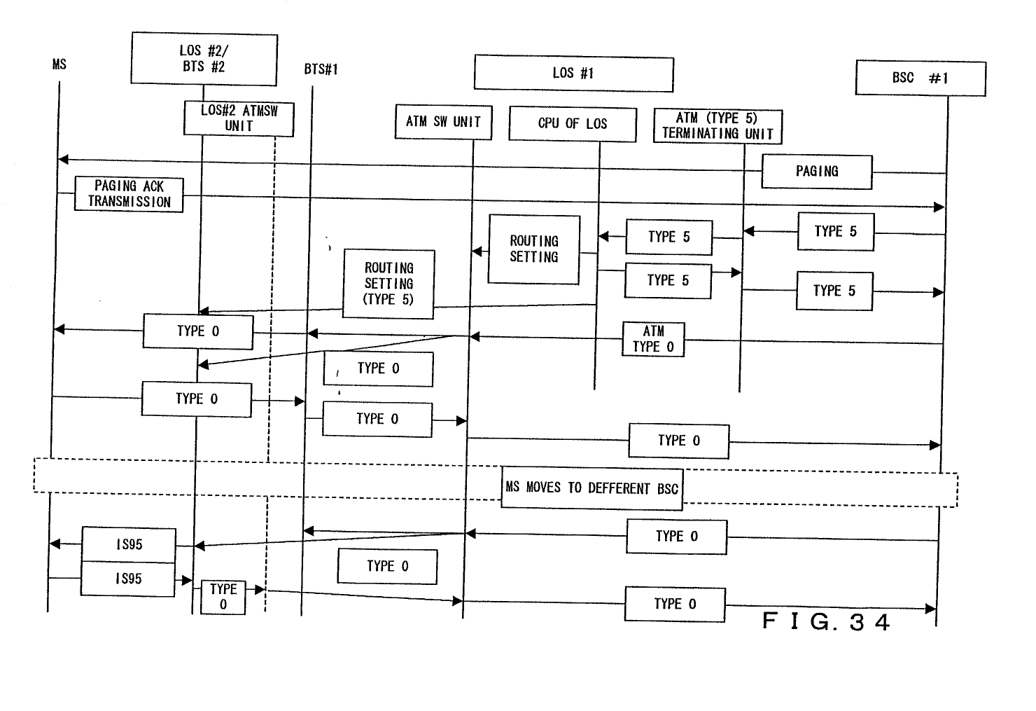

FIG. 34 shows the sequence of FIG. 33 more specifically. Since the fundamental sequence is similar to that shown in FIG. 14 in this case, its detailed explanation is omitted here. However, there is only a difference in a point that a composite cell is not used, and each ATM cell is transmitted unchanged with a high-speed communication, namely, a TYPE 0 cell is transmitted directly from the ATM SW unit of the LOS #1 to the BSC #1.

As described above, according to the present invention, a simple and low-cost mobile communications system can be built in a fixed wireless communications system.

What is claimed is:

1. A mobile communications system in a fixed wireless telephone network, which is configured by at least a fixed network local exchange, a wireless base station controller subordinate to the fixed network local exchange, and a plurality of wireless base station transceiver subsystems subordinate to the wireless base station controller, comprising
an inter-controller SW unit relaying voice data and control information, which are exchanged between the wireless base station controller and the plurality of wireless base station transceiver subsystems, between an arbitrary wireless base station controller and an arbitrary wireless base station transceiver subsystem.

2. The mobile communications system according to claim 1, wherein
said inter-controller SW unit transfers the voice data and the control information, which are transmitted from the wireless base station controller to the plurality of wireless base station transceiver subsystems, with a broadcast communication.

3. The mobile communications system according to claim 1, wherein
said inter-controller SW device determines a routing method for the voice data based on the received control information.

4. The mobile communications system according to claim 1, wherein
the wireless base station controller generates control information based on an identifier of a base station transceiver subsystem to which a mobile station belongs, and/or an identifier of the mobile station, and transmits generated control information to said inter-controller SW unit.

5. The mobile communications system according to claim 1 wherein
the wireless base station controller performs hand-off control via said inter-controller SW unit based on voice quality information from a mobile station.

6. The mobile communications system according to claim 1, wherein
a plurality of inter-controller SW units are connected by an optical communications path.

7. The mobile communications system according to claim 1, wherein
information is exchanged with an ATM communication between the wireless base station controller, the plurality of wireless base station transceiver subsystems, and said inter-controller SW device.

8. The mobile communications system according to claim 7, wherein
voice data is exchanged with a composite cell.

9. A mobile communications method for use in a fixed wireless telephone network, which is configured by at least a fixed network local exchange, a wireless base station controller subordinate to the fixed network local exchange, and a plurality of wireless base station transceiver subsystems subordinate to the wireless base station controller, comprising
(a) relaying voice data and control information, which are exchanged between the wireless base station controller and the plurality of wireless base station transceiver subsystems, between an arbitrary wireless base station controller and an arbitrary base station transceiver subsystem.

10. The mobile communications method according to claim 9, wherein
voice data and control information, which are transmitted from the wireless base station controller, are transferred to the plurality of wireless base station transceiver subsystems, with a broadcast communication in the step (a).

11. The mobile communications method according to claim 9, wherein
a routing method for voice data is determined based on the received control information in the step (a).

12. The mobile communications method according to claim 9, wherein
the wireless base station controller generates control information based on an identifier of a base station transceiver subsystem to which a mobile station belongs, and/or an identifier of the mobile station, and transmits generated control information via step (a).

13. The mobile communications method according to claim 9, wherein
the wireless base station controller performs hand-off control based on voice quality information from a mobile station via the step (a).
